(19) United States
(12) Patent Application Publication
(10) Pub. No.: US 2026/0067033 A1
(43) Pub. Date: Mar. 5, 2026

(54) COMMUNICATION METHOD AND RELATED APPARATUS

(71) Applicant: HUAWEI TECHNOLOGIES CO., LTD., Shenzhen (CN)

(72) Inventors: Xiaojun Xi, Shenzhen (CN); Xiaoyan Bi, Shanghai (CN); Yong Liu, Shanghai (CN)

(73) Assignee: HUAWEI TECHNOLOGIES CO., LTD., Shenzhen (CN)

(21) Appl. No.: 19/382,149

(22) Filed: Nov. 6, 2025

Related U.S. Application Data
(63) Continuation of application No. PCT/CN2023/093268, filed on May 10, 2023.

(51) Int. Cl. H04L 1/06; H04L 5/00; H04W 72/0453

(52) U.S. Cl. CPC H04L 1/0668; H04L 5/0046; H04W 72/0453

(57) ABSTRACT

Embodiments of this application provide a communication method and a related apparatus. The method includes: receiving configuration information; and sending a reference signal based on the configuration information. The configuration information indicates to send the reference signal through a first transmit port group using a first orthogonal code sequence, the configuration information includes a configuration of the first transmit port group and/or a configuration of the first orthogonal code sequence, a quantity of first transmit port groups is less than or equal to a total quantity X of transmit port groups of a terminal device, a quantity of first orthogonal code sequences is less than or equal to a total quantity NG of transmit ports in the first transmit port group.

### CROSS-REFERENCE TO RELATED APPLICATIONS

This application is a continuation of International Application No. PCT/CN2023/093268, filed on May 10, 2023, the disclosure of which is hereby incorporated by reference in its entirety.

### TECHNICAL FIELD

This application relates to the field of wireless communication technologies, and in particular, to a communication method and a related apparatus.

### BACKGROUND

In a process of communication between a network device and a terminal device, the network device needs to obtain channel state information. The channel state information may be obtained by using a reference signal. For example, in an uplink channel estimation solution, the terminal device may send a reference signal, for example, a sounding reference signal (SRS), to the network device. After receiving the reference signal from the terminal device, the network device may determine a channel matrix based on the reference signal. The channel matrix may indicate channel state information of a transmit port, a receive port, and a scheduled frequency domain unit. In this way, in some possible design solutions, when sending a reference signal, the terminal device needs to send the reference signal on a frequency domain resource that can be used to send the reference signal and a transmit port that can be used to send the reference signal.

However, with the development of wireless communication technologies, a size of an antenna greatly increases. If the foregoing solution is used, when a quantity of transmit ports is large, overheads of the reference signal used for channel estimation also increase greatly. Therefore, how to reduce the overheads of the reference signal is an urgent problem to be resolved.

### SUMMARY

Embodiments of this application disclose a communication method and a related apparatus, to reduce indication overheads of a reference signal, so that the reference signal is sent through some transmit port groups using an orthogonal code sequence (OCS), or the reference signal is sent through a transmit port group that uses some OCSs, to reduce overheads of the reference signal, improve a transmit power and a signal-to-noise ratio (SNR) of communication transmission, reduce a measurement delay, and improve channel estimation accuracy.

According to a first aspect, an embodiment of this application discloses a communication method. The method may be applied to a terminal device, an apparatus (for example, a chip, a chip system, or a circuit) in the terminal device, or an apparatus that can be used in combination with the terminal device. The method includes: receiving configuration information; and sending a reference signal based on the configuration information. The configuration information indicates to send the reference signal through a first transmit port group using a first OCS, the configuration information includes a configuration of the first transmit port group and/or a configuration of the first OCS, a quantity of first transmit port groups is less than or equal to a total quantity X of transmit port groups of the terminal device, a quantity of first OCSs is less than or equal to a total quantity of transmit ports (NG) in the first transmit port group, when the quantity of first transmit port groups is equal to X, the quantity of first OCSs is less than NG, and when the quantity of first OCSs is equal to NG, the quantity of first transmit port groups is less than X. In this way, when the configuration information includes a configuration of all transmit port groups, the configuration information does not include a configuration of all OCSs, and when the configuration information includes the configuration of all the OCSs, the configuration information does not include the configuration of all the transmit port groups. In other words, the quantity of first OCSs and the quantity of first transmit port groups are not simultaneously equal to a maximum value, and the configuration information indicates a configuration of some transmit port groups and/or a configuration of some OCSs, to reduce indication overheads. After receiving the configuration information, the terminal device may send the reference signal through some transmit port groups using an OCS or through a transmit port group using some OCSs, and does not need to send the reference signal through all transmit port groups using all OCSs. This reduces overheads of the reference signal, can improve a transmit power and an SNR of communication transmission, can reduce a measurement delay, and can improve channel estimation accuracy.

With reference to the first aspect, in some feasible examples, when the configuration information includes the configuration of the first transmit port group and the configuration of the first OCS, the reference signal is sent through the first transmit port group using the first OCS. In this way, a configuration of some transmit port groups and a configuration of some OCSs are indicated, to reduce indication overheads. After receiving the configuration information, the terminal device may send the reference signal through some transmit port groups using some OCSs, so that overheads of the reference signal are reduced, a transmit power and an SNR of communication transmission can be improved, a measurement delay can be reduced, and channel estimation accuracy can be improved.

Alternatively, with reference to the first aspect, in some feasible examples, when the configuration information includes the configuration of the first OCS, and NG is equal to the total quantity N of transmit ports of the terminal device, the reference signal is sent through the N transmit ports using the first OCS. In this way, the configuration information does not indicate the configuration of the transmit port group, to reduce indication overheads. Because NG=N, the terminal device includes one transmit port group, that is, X=1, the first transmit port group includes all the transmit ports (namely, the N transmit ports), and the quantity of first transmit port groups is equal to X. In this case, the quantity of first OCSs is less than NG, and the terminal device may send the reference signal on all the transmit port groups by using some OCSs, to reduce overheads of the reference signal, improve a transmit power and an SNR of communication transmission, reduce a measurement delay, and improve channel estimation accuracy.

Alternatively, with reference to the first aspect, in some feasible examples, when the configuration information includes the configuration of the first transmit port group, the reference signal is sent through the first transmit port group using NG OCSs. In this way, the configuration information does not indicate the first OCS used to send the reference signal. This further reduces indication overheads in comparison with a scenario of indicating the first transmit port group and the first OCS. Because the terminal device does not know an OCS used to send the reference signal, all OCSs, namely, the NG OCSs, need to be used. When the quantity of first OCSs is equal to NG, the quantity of first transmit port groups is less than X. Therefore, some transmit port groups using all OCSs may be used to send the reference signal, to reduce overheads of the reference signal, improve a transmit power and an SNR of communication transmission, reduce a measurement delay, and improve channel estimation accuracy.

Alternatively, with reference to the first aspect, in some feasible examples, when the configuration information includes the configuration of the first OCS, and NG is less than the total quantity N of transmit ports of the terminal device, the reference signal is sent through the X transmit port groups using the first OCS. In this way, the configuration information does not indicate the configuration of the transmit port group. This further reduces indication overheads in comparison with a scenario of indicating the first transmit port group and the first OCS. Because NG is less than N, the first transmit port group does not include all the transmit ports, and X is greater than 1. In addition, because the first transmit port group used to send the reference signal is not indicated, the terminal device does not know the transmit port group used to send the reference signal, and needs to use all the transmit port groups, that is, the X transmit port groups. In other words, the quantity of first transmit port groups is equal to X. In this case, the quantity of first OCSs is less than NG. Therefore, all the transmit port groups using some OCSs may be used to send the reference signal, to reduce overheads of the reference signal, improve a transmit power and an SNR of communication transmission, reduce a measurement delay, and improve channel estimation accuracy.

With reference to the first aspect, in some feasible examples, the method further includes: receiving first indication information, where the first indication information indicates division of the transmit port groups and/or the OCS. In this way, efficiency of obtaining the transmit port group and the OCS can be improved, and efficiency of sending the reference signal through the transmit port group using the OCS can be improved.

According to a second aspect, an embodiment of this application discloses another communication method. The method may be applied to a network device, an apparatus (for example, a chip, a chip system, or a circuit) in the network device, or an apparatus that can be used in combination with the network device. The method includes: sending configuration information; and receiving a reference signal based on the configuration information. The configuration information indicates to send the reference signal through a first transmit port group using a first OCS, the configuration information includes a configuration of the first transmit port group and/or a configuration of the first OCS, a quantity of first transmit port groups is less than or equal to a total quantity X of transmit port groups of a terminal device, a quantity of first OCSs is less than or equal to a total quantity NG of transmit ports in the first transmit port group, when the quantity of first transmit port groups is equal to X, the quantity of first OCSs is less than NG, and when the quantity of first OCSs is equal to NG, the quantity of first transmit port groups is less than X. In this way, the quantity of first OCSs and the quantity of first transmit port groups are not simultaneously equal to a maximum value, and the configuration information indicates a configuration of some transmit port groups and/or a configuration of some OCSs, to reduce indication overheads. After receiving the configuration information, the terminal device may send the reference signal through some transmit port groups using an OCS or through a transmit port group using some OCSs, and does not need to send the reference signal through all transmit port groups using all OCSs. This reduces overheads of the reference signal, can improve a transmit power and an SNR of communication transmission, can reduce a measurement delay, and can improve channel estimation accuracy.

With reference to the first aspect or the second aspect, in some feasible examples, the configuration information is carried in control signaling, the control signaling includes first sub-signaling and/or second sub-signaling, the first sub-signaling indicates the configuration of the first transmit port group, the second sub-signaling indicates the configuration of the first OCS, a signaling size of the first sub-signaling is L1 and satisfies

$$L 1 = ⌊ {log}_{2}^{N / NG} ⌋ ,$$

a signaling size or the second sub-signaling is L2 and satisfies

$$L 2 = ⌊ {log}_{2}^{NG} ⌋ ,$$

and N is a total quantity of transmit ports of the terminal device.

With reference to the first aspect or the second aspect, in some feasible examples, X=N/NG; and when NG is equal to N, and X is equal to 1, the control signaling includes the second sub-signaling; or when NG is equal to 1, and X is greater than 1 and equal to N, the control signaling includes the first sub-signaling. It may be understood that, when X=N/NG, it indicates that quantities of transmit ports in all the transmit port groups are equal. When NG is equal to N, it indicates that all the N transmit ports are grouped into one transmit port group. The network device has known that the transmit ports in the transmit port group are all the transmit ports of the terminal device. In this case, the control signaling may not include the first sub-signaling, but includes the second sub-signaling. When NG is equal to 1, and X is greater than 1 and equal to N, it indicates that each transmit port is grouped into one transmit port group. A solution in which the reference signal is sent through a transmit port group is not used. An OCS used by the transmit port group does not need to be determined. In this case, the control signaling may not include the second sub-signaling, but include the first sub-signaling.

In an embodiment, the control signaling may include third sub-signaling. The third sub-signaling indicates a configuration of a frequency domain position of the reference signal.

With reference to the second aspect, in some feasible examples, the method further includes: restoring a first channel based on the reference signal. In this way, a channel between the terminal device and the network device is restored by using the reference signal used for channel estimation, so that restoration accuracy can be improved.

With reference to the second aspect, in some feasible examples, when the configuration information includes the configuration of the first transmit port group and the configuration of the first OCS, restoring the first channel based on the reference signal includes: obtaining a second channel based on the reference signal; and restoring the first channel based on the second channel. In this way, because the configuration information indicates the configuration of the first transmit port group and the configuration of the first OCS, the reference signal is sent through the first transmit port group using the first OCS, and the second channel for transmitting the reference signal may be restored based on the received reference signal. Then, OCS decoding is performed on the second channel, to restore the first channel between the terminal device and the network device, so that accuracy of channel restoration can be improved, and accuracy of channel estimation can be improved.

Alternatively, with reference to the second aspect, in some feasible examples, when the configuration information includes the configuration of the first OCS, and NG is equal to the total quantity N of transmit ports of the terminal device, restoring the first channel based on the reference signal includes: obtaining a second channel based on the reference signal; and restoring the first channel based on the second channel. In this way, because the configuration information does not indicate the configuration of the first transmit port group, NG=N, and X=1, the quantity of first OCSs is less than NG, the reference signal is sent through the entire transmit port group (all transmit ports, namely, the N transmit ports) using some OCSs, and the second channel for transmitting the reference signal may be restored based on the received reference signal. Then, OCS decoding is performed on the second channel, to restore the first channel between the terminal device and the network device, so that accuracy of channel restoration can be improved, and accuracy of channel estimation can be improved.

Alternatively, with reference to the second aspect, in some feasible examples, when the configuration information includes the configuration of the first transmit port group, restoring the first channel based on the reference signal includes: obtaining a third channel based on the reference signal, and selecting a second channel from the third channel; and restoring the first channel based on the second channel. In this way, because the configuration information does not indicate the configuration of the first OCS, the quantity of first OCSs is equal to NG. In this case, the quantity of first transmit port groups is less than X. The reference signal is sent through some transmit port groups that use all OCSs (namely, NG OCSs). The third channel for transmitting the reference signal needs to be restored based on the received reference signal, and then actually used OCSs and transmit port groups are selected from the third channel, to obtain the second channel. Then, OCS decoding is performed on the second channel, to restore the first channel between the terminal device and the network device, so that accuracy of channel restoration can be improved, and accuracy of channel estimation can be improved.

Alternatively, with reference to the second aspect, in some feasible examples, when the configuration information includes the configuration of the first OCS, and NG is less than the total quantity N of transmit ports of the terminal device, restoring the first channel based on the reference signal includes: obtaining a fourth channel based on the reference signal, and selecting a second channel from the fourth channel; and restoring the first channel based on the second channel. In this way, because the configuration of the first transmit port group is not indicated, all the transmit port groups (namely, the X transmit port groups) need to be used to send the reference signal. In this case, the quantity of first OCSs is less than NG, and the reference signal is sent through all the transmit port groups using some OCSs. The fourth channel for sending the reference signal needs to be restored based on the received reference signal, and then actually used OCSs and transmit port groups are selected from the fourth channel, to obtain the second channel. Then, OCS decoding is performed on the second channel, to restore the first channel between the terminal device and the network device, so that accuracy of channel restoration can be improved, and accuracy of channel estimation can be improved.

With reference to the second aspect, in some feasible examples, the method further includes: aggregating the X transmit port groups based on NG OCSs to obtain a first vector; concatenating, based on channel information of T time domain units, vectors that correspond to the first vector and that are in the T time domain units, to obtain a first matrix; processing the first matrix to obtain a pattern of the reference signal; and determining the configuration information based on the pattern of the reference signal.

A quantity of elements in the first vector is NMR1, Mis a total quantity of receive ports of the network device, R1 is a quantity of orthogonal frequency domain units, and the first vector may be understood as a vector in orthogonal code domain. A quantity of columns of the first matrix is NMR1, a quantity of rows of the first matrix is T, and T is greater than 1. The first matrix may be understood as a vector related to time T in orthogonal code domain.

With reference to the second aspect, in some feasible examples, processing the first matrix to obtain the pattern of the reference signal includes: decomposing the first matrix to obtain a second matrix; compressing the second matrix to obtain a third matrix and a fourth matrix; and determining the pattern of the reference signal based on the fourth matrix.

A quantity of columns of the second matrix is NMR1, a quantity of rows of the second matrix is R2, and R2 is a quantity of orthogonal subsets in a set including the X transmit port groups and the NG OCSs. The second matrix may be understood as a base matrix in orthogonal code domain. A quantity of rows of the third matrix, a quantity of columns of the third matrix, and a quantity of columns of the fourth matrix are R2, a quantity of rows of the fourth matrix is NMR1, and a location of a row in which an element whose value is 1 in the fourth matrix is located is used to determine a frequency domain position of the reference signal. The third matrix may be understood as a base matrix in another orthogonal code domain, and the fourth matrix may be understood as a selection matrix in orthogonal code domain.

With reference to the second aspect, in some feasible examples, the method may further include: processing a fifth matrix to obtain a sixth matrix; constructing a second vector based on the N transmit ports, the M receive ports, and R1 frequency domain units that are selected by using the sixth matrix; and splitting the N transmit ports based on the second vector to obtain the X transmit port groups.

The fifth matrix is a matrix including the N transmit ports, the M receive ports, and P frequency domain units, and the fifth matrix may be understood as a three-dimensional matrix including dimensions respectively corresponding to a transmit port, a receive port, and frequency domain. A quantity of columns of the second vector is 1, and a quantity of rows of the second vector is NMR1. The second vector may be understood as a one-dimensional vector obtained by splicing three dimensions of a transmit port, a receive port, and a frequency domain. A quantity of rows of the sixth matrix is P, a quantity of columns of the sixth matrix is R1, and P is a total quantity of frequency domain units. A location of a row in which an element whose value is 1 in the sixth matrix is located is used to determine the frequency domain position of the reference signal. The sixth matrix may be understood as a selection matrix based on the dimension of the frequency domain.

With reference to the second aspect, in some feasible examples, the method further includes: restoring the first channel based on the second channel, the second matrix, and the fourth matrix. In this way, accuracy of channel restoration can be further improved, and accuracy of channel estimation can be improved.

With reference to the second aspect, in some feasible examples, the method further includes: sending first indication information, where the first indication information indicates division of the transmit port groups and/or the OCS. In this way, the terminal device may determine the transmit port group and/or the OCS based on the first indication information, so that efficiency of obtaining the transmit port group and/or the OCS can be improved, thereby helping improve efficiency of sending the reference signal through the transmit port group using the OCS.

With reference to the first aspect or the second aspect, in some feasible examples, the configuration information further includes a configuration of the frequency domain position of the reference signal. In this way, the reference signal may be sent at the frequency domain position of the reference signal.

According to a third aspect, an embodiment of this application discloses a communication apparatus. The apparatus may be the terminal device, the apparatus in the terminal device, or the apparatus that can be used in combination with the terminal device. The apparatus has a function of implementing any example of the first aspect. The function may be implemented by hardware, or may be implemented by hardware executing corresponding software. The hardware or the software includes one or more modules or units or means corresponding to the function.

The following uses a unit as an example. The apparatus includes: a receiving unit, configured to receive configuration information; and a sending unit, configured to send a reference signal based on the configuration information. The configuration information indicates to send the reference signal through a first transmit port group using a first OCS, the configuration information includes a configuration of the first transmit port group and/or a configuration of the first OCS, a quantity of first transmit port groups is less than or equal to a total quantity X of transmit port groups of the terminal device, a quantity of first OCSs is less than or equal to a total quantity NG of transmit ports in the first transmit port group, when the quantity of first transmit port groups is equal to X, the quantity of first OCSs is less than NG, and when the quantity of first OCSs is equal to NG, the quantity of first transmit port groups is less than X.

With reference to the third aspect, in some feasible examples, when the configuration information includes the configuration of the first transmit port group and the configuration of the first OCS, the reference signal is sent through the first transmit port group using the first OCS.

Alternatively, with reference to the third aspect, in some feasible examples, when the configuration information includes the configuration of the first OCS, and NG is equal to a total quantity N of transmit ports of the terminal device, the reference signal is sent through the N transmit ports using the first OCS.

Alternatively, with reference to the third aspect, in some feasible examples, when the configuration information includes the configuration of the first transmit port group, the reference signal is sent through the first transmit port group using NG OCSs.

Alternatively, with reference to the third aspect, in some feasible examples, when the configuration information includes the configuration of the first OCS, and NG is less than a total quantity N of transmit ports of the terminal device, the reference signal is sent through the X transmit port groups using the first OCS.

With reference to the third aspect, in some feasible examples, the receiving unit is further configured to receive first indication information, where the first indication information indicates division of the transmit port groups and/or the OCS.

With reference to the third aspect, in some feasible examples, the receiving unit and the sending unit may be unified as a transceiver unit. It may be understood that when the communication apparatus is a device, the transceiver unit may be a transceiver in the apparatus, for example, implemented through an antenna, a feeder, a codec, or the like in the communication apparatus; or if the communication apparatus is a chip disposed in a device, the transceiver unit may be an input/output interface of the chip, for example, an input/output circuit or a pin.

According to a fourth aspect, an embodiment of this application discloses another communication apparatus. The apparatus may be the network device, may be an apparatus in the network device, or may be an apparatus that can be used in combination with the network device. The apparatus has a function of implementing any example of the second aspect. The function may be implemented by hardware, or may be implemented by hardware executing corresponding software. The hardware or the software includes one or more modules or units or means corresponding to the function.

The following uses a unit as an example. The apparatus includes: a sending unit, configured to send configuration information; and a receiving unit, configured to receive a reference signal based on the configuration information. The configuration information indicates to send the reference signal through a first transmit port group using a first OCS, the configuration information includes a configuration of the first transmit port group and/or a configuration of the first OCS, a quantity of first transmit port groups is less than or equal to a total quantity X of transmit port groups of the terminal device, a quantity of first OCSs is less than or equal to a total quantity NG of transmit ports in the first transmit port group, when the quantity of first transmit port groups is equal to X, the quantity of first OCSs is less than NG, and when the quantity of first OCSs is equal to NG, the quantity of first transmit port groups is less than X.

With reference to the third aspect or the fourth aspect, in some feasible examples, the configuration information is carried in control signaling, the control signaling includes first sub-signaling and/or second sub-signaling, the first sub-signaling indicates the configuration of the first transmit port group, the second sub-information indicates the configuration of the first OCS, a signaling size of the first sub-signaling is L1 and satisfies

$$L 1 = ⌊ {log}_{2}^{N / NG} ⌋ ,$$

a signaling size or the second sub-signaling is L2 and satisfies

$$L 2 = ⌊ {log}_{2}^{NG} ⌋ ,$$

and N is a total quantity of transmit ports of the terminal device.

With reference to the third aspect or the fourth aspect, in some feasible examples, X=N/NG; and when NG is equal to N, and X is equal to 1, the control signaling includes the second sub-signaling; or when NG is equal to 1, and X is greater than 1 and equal to N, the control signaling includes the first sub-signaling.

With reference to the fourth aspect, in some feasible examples, the apparatus further includes: a processing unit, configured to restore a first channel based on the reference signal.

With reference to the fourth aspect, in some feasible examples, when the configuration information includes the configuration of the first transmit port group and the configuration of the first OCS, the processing unit is configured to: obtain a second channel based on the reference signal; and restore the first channel based on the second channel.

Alternatively, with reference to the fourth aspect, in some feasible examples, when the configuration information includes the configuration of the first OCS, and NG is equal to the total quantity N of transmit ports of the terminal device, the processing unit is configured to: obtain a second channel based on the reference signal; and restore the first channel based on the second channel.

Alternatively, with reference to the fourth aspect, in some feasible examples, when the configuration information includes the configuration of the first transmit port group, the processing unit is configured to: obtain a third channel based on the reference signal, and select a second channel from the third channel; and restore the first channel based on the second channel. Alternatively, with reference to the fourth aspect, in some feasible examples, when the configuration information includes the configuration of the first OCS, and NG is less than the total quantity N of transmit ports of the terminal device, the processing unit is configured to: obtain a fourth channel based on the reference signal, and select a second channel from the fourth channel; and restore the first channel based on the second channel.

With reference to the fourth aspect, in some feasible examples, the apparatus further includes: the processing unit, configured to aggregate the X transmit port groups based on NG OCSs to obtain a first vector; concatenate, based on channel information of T time domain units, vectors that correspond to the first vector and that are in the T time domain units, to obtain a first matrix; process the first matrix to obtain a pattern of the reference signal; and determine the configuration information based on the pattern of the reference signal. A quantity of elements in the first vector is NMR1, M is a total quantity of receive ports of the network device, and R1 is a quantity of orthogonal frequency domain units. A quantity of columns of the first matrix is NMR1, and a quantity of rows of the first matrix is T.

With reference to the fourth aspect, in some feasible examples, the processing unit is configured to: decompose the first matrix to obtain a second matrix; compress the second matrix to obtain a third matrix and a fourth matrix; and determine the pattern of the reference signal based on the fourth matrix, where a quantity of columns of the second matrix is NMR1, a quantity of rows of the second matrix is R2, a quantity of rows of the third matrix, a quantity of columns of the third matrix, and a quantity of columns of the fourth matrix are R2, and a quantity of rows of the fourth matrix is NMR1.

With reference to the fourth aspect, in some feasible examples, the processing unit is further configured to: process a fifth matrix to obtain a sixth matrix; construct a second vector based on the N transmit ports, the M receive ports, and R1 frequency domain units that are selected by using the sixth matrix; and split the N transmit ports based on the second vector to obtain the X transmit port groups, where the fifth matrix is a matrix including the N transmit ports, the M receive ports, and P frequency domain units, a quantity of rows of the sixth matrix is P, a quantity of columns of the sixth matrix is R1, P is a total quantity of frequency domain units, and a location of a row in which an element whose value is 1 in the sixth matrix is located is used to determine a frequency domain position of the reference signal.

With reference to the fourth aspect, in some feasible examples, the processing unit is further configured to restore the first channel based on the second channel, the second matrix, and the fourth matrix.

With reference to the fourth aspect, in some feasible examples, the sending unit is further configured to send first indication information, where the first indication information indicates division of the transmit port groups and/or the OCS.

With reference to the third aspect or the fourth aspect, in some feasible examples, the configuration information further includes a configuration of the frequency domain position of the reference signal.

With reference to the fourth aspect, in some feasible examples, the receiving unit and the sending unit may be unified as a transceiver unit. It may be understood that when the communication apparatus is a device, the transceiver unit may be a transceiver in the apparatus, for example, implemented through an antenna, a feeder, a codec, or the like in the communication apparatus; or if the communication apparatus is a chip disposed in a device, the transceiver unit may be an input/output interface of the chip, for example, an input/output circuit or a pin. The processing unit may be a processing circuit in the chip, for example, a logic circuit.

It should be understood that content of the third aspect corresponds to the content of the first aspect. For corresponding features of the third aspect and achieved beneficial effects, refer to the descriptions of the first aspect. Content of the fourth aspect corresponds to the content of the second aspect. For corresponding features of the fourth aspect and achieved beneficial effects, refer to the descriptions of the second aspect. To avoid repetition, detailed descriptions are appropriately omitted herein.

According to a fifth aspect, an embodiment of this application discloses another communication apparatus. The apparatus may include a processor and a storage medium. The storage medium stores instructions. When the instructions are run by the processor, the apparatus is enabled to perform the method in any one of the foregoing aspects or the possible examples. In some feasible examples, the apparatus may be a chip or a chip system.

In some feasible examples, the apparatus may be a terminal device or a network device. The apparatus further includes a transceiver, configured to receive and send data and/or signaling.

According to a sixth aspect, an embodiment of this application provides a communication system. The communication system includes a terminal device and a network device. The terminal device and the network device, when running in the communication system, are configured to perform the method in any one of the foregoing aspects or the possible examples.

According to a seventh aspect, an embodiment of this application provides a computer-readable storage medium. The computer-readable storage medium stores instructions. When the instructions are run by a processor, the method according to any one of the foregoing aspects or the possible examples is performed.

According to an eighth aspect, an embodiment of this application provides a computer program product. The computer program product includes instructions. When the instructions are run by a processor, the method according to any one of the foregoing aspects or the possible examples is performed.

According to a ninth aspect, this application provides a chip, including a processor, configured to: invoke, from a memory, instructions stored in the memory, and run the instructions, to enable a communication apparatus in which the chip is installed to perform the method according to any one of the foregoing aspects or the possible examples.

According to a tenth aspect, this application provides another chip, including an input interface, an output interface, and a processing circuit. The input interface, the output interface, and the circuit are connected through an internal connection path, and the processing circuit is configured to perform the method according to any one of the foregoing aspects or the possible examples. In an embodiment, the chip further includes a memory. The input interface, the output interface, a processor, and the memory are connected through an internal connection path. The processor is configured to execute code in the memory. When the code is executed, the processor is configured to perform the method according to any one of the foregoing aspects or the possible examples.

According to an eleventh aspect, this application provides a chip system, including at least one processor and a communication interface. The communication interface and the at least one processor are interconnected through a line, and the at least one processor is configured to run a computer program or instructions, to perform the method according to any one of the foregoing aspects or the possible examples.

It should be understood that mutual reference may be made to the implementations and beneficial effect of the foregoing plurality of aspects.

### BRIEF DESCRIPTION OF DRAWINGS

The following describes accompanying drawings used in embodiments of this application.

FIG. 1A and FIG. 1B each are a diagram of an architecture of a communication system according to an embodiment of this application;

FIG. 2 is a diagram of a method for processing a reference signal according to an embodiment of this application;

FIG. 3A and FIG. 3B each are a diagram of an antenna port group division method according to this application;

FIG. 4A to FIG. 4D each show a pattern of a reference signal according to an embodiment of this application;

FIG. 5 is a diagram of simulation of downlink average spectral efficiency according to an embodiment of this application;

FIG. 6 is a diagram of interaction of a communication method according to an embodiment of this application;

FIG. 7A to FIG. 7C each are a diagram of control signaling according to an embodiment of this application;

FIG. 8A to FIG. 8D each are a diagram in which a terminal device sends a reference signal through a first transmit port group using a first OCS according to an embodiment of this application;

FIG. 9 is a diagram of a structure of a communication apparatus according to an embodiment of this application;

FIG. 10 is a diagram of a structure of another communication apparatus according to an embodiment of this application; and

FIG. 11 is a diagram of a structure of a terminal device according to an embodiment of this application.

### DESCRIPTION OF EMBODIMENTS

Technical solutions in embodiments of this application may be applied to various communication systems, for example, a long term evolution (LTE) system, a new radio (NR) system, a public land mobile network (PLMN) system, an advanced long term evolution (LTE advanced, LTE-A) system, a device-to-device (D2D) communication system, a machine-to-machine (M2M) communication system, an internet of things (IoT), a narrowband internet of thing (NB-IoT), an integrated sensing and communication system, a frequency division duplex (FDD) system, a time division duplex (TDD) system, a non-terrestrial communication (NTN) system, a wireless projection communication system, and an integrated access and backhaul (IAB) communication system, and may be applied to a communication system (for example, a 6G communication system) evolved after 5G, or may be a non-third generation partnership project (3rd generation partnership project, 3GPP) communication system or the like. This is not limited.

A communication method provided in embodiments of this application may be applied to various communication scenarios, for example, one or more of enhanced mobile broadband (eMBB), ultra-reliable low-latency communication (URLLC), machine type communication (MTC), massive machine type communication (mMTC), enhanced machine type communication (eMTC), IoT, NB-IoT, a customer premise equipment (CPE), augmented reality (AR), virtual reality (VR), D2D, V2X, and the like.

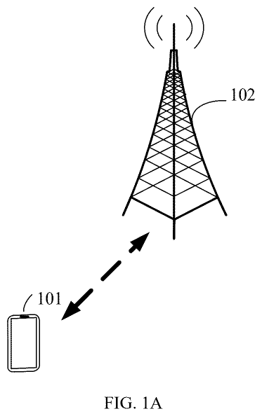

FIG. 1A is a diagram of an architecture of a communication system according to an embodiment of this application. As shown in FIG. 1A, the communication system may include a terminal device 101 and a network device 102. The terminal device 101 may be connected to the network device 102 in a wireless manner. The terminal device 101 may be at a fixed location, or may be movable. The terminal device 101 and the network device 102 may be deployed on land, for example, deployed as indoor or outdoor devices, or handheld or vehicle-mounted devices. Alternatively, the terminal device 101 and the network device 102 may be deployed on a water surface, or in an airplane, a balloon, a satellite, or the like in the air. This is not limited herein.

Communication between the terminal device 101 and the network device 102, between the network devices 102, and between the terminal devices 101 may be performed by using a licensed spectrum, may be performed by using an unlicensed spectrum, or may be performed by using both the licensed spectrum and the unlicensed spectrum. Spectrum resources used by the terminal device 101 and the network device 102 are not limited in this application.

The terminal device 101 is a user-side entity configured to receive or transmit a signal. The terminal device 101 may also be referred to as a terminal, a user equipment (UE), a mobile station, a mobile terminal, or the like. The terminal device may be used in various communication scenarios, for example, D2D communication, V2X communication, MTC, IoT, VR, AR, industrial control, self-driving, telemedicine, a smart grid, smart furniture, a smart office, a smart wearable, smart transportation, and a smart city. The terminal device may be a mobile phone, a tablet computer (pad), a computer with a wireless transceiver function, a wearable device, an aerospace device, an uncrewed aerial vehicle device, or the like. In embodiments of this application, a chip used in the foregoing device may also be referred to as a terminal device.

The network device 102 may be an entity configured to transmit or receive a signal, and is mainly configured to: implement functions such as a radio physical control function, resource scheduling and radio resource management, radio access control, and mobility management, and provide a reliable wireless transmission protocol, a reliable data encryption protocol, and the like. The network device may support wired access and may further support wireless access, and may be referred to as an access network device below.

In an embodiment, the access network device may be an access network (AN)/radio access network (RAN) device, and includes a plurality of AN/RAN nodes. The AN/RAN node may include but is not limited to: an access point (AP), an enhanced NodeB (eNB), a home base station (for example, a home evolved NodeB, or a home NodeB, HNB), a baseband unit (BBU), a next generation base station (NR NodeB, gNB), a transmission reception point (TRP), a transmission point (TP), or another access node, for example, a wireless relay node or a wireless backhaul node. Alternatively, the AN/RAN node may be one or more formed antenna panels, or may be a network node that forms a gNB or a transmission point, for example, a BBU or a distributed unit (DU), or may be a device that undertakes a base station function in a communication system such as D2D, V2X, M2M, or U2U. Alternatively, the AN/RAN node may be a radio controller in a cloud radio access network (CRAN) scenario, may be an open access network (open RAN, O-RAN or ORAN), may be a base station in the communication system evolved after the 5G communication system, for example, an xNodeB in the 6G communication system, or may be an access network device or the like in a PLMN evolved after the 5G communication system. This is not limited herein.

Main functions of the access network device include at least one of radio resource management, internet protocol (IP) header compression and user data flow encryption, mobility management entity (MME) selection during attachment of a user equipment, routing of user plane data to a service gateway (SGW), paging message organization and sending, broadcast message organization and sending, measurement for a purpose of mobility or scheduling, measurement report configuration, and the like.

In an embodiment, the network device may include a central unit (CU), a distributed unit (DU), and the like. The CU may be further divided into a CU-control plane (CP), a CU-user plane (user plane, UP), and the like. Alternatively, the network device may be an antenna unit (RU) or the like. Alternatively, the network device may be in an ORAN architecture or the like. A deployment manner of the network device is not limited in this embodiment of this application. For example, when the network device is in the ORAN architecture, the network device may be an access network device in the ORAN, a module in the access network device, or the like. In an ORAN system, a CU may also be referred to as an open (open, O)-CU, a DU may also be referred to as an O-DU, a CU-CP may also be referred to as an O-CU-CP, a CU-UP may also be referred to as an O-CU-UP, and an RU may also be referred to as an O-RU.

In an embodiment, the network device may further include a core network device, configured to: maintain subscription data of a mobile network, manage a network element of the mobile network, and provide functions such as session management, mobility management, policy management, and security authentication for the terminal device.

In an embodiment, the network device may further include a data network device, configured to provide a service for a user. Generally, a client is the terminal device, and a server is the data network device. A data network provided by the data network device may be a private network, for example, a local area network. The data network may alternatively include an external network that is not managed by an operator, for example, the Internet. The data network may alternatively include a dedicated network jointly deployed by operators, for example, a network that provides an IP multimedia subsystem (IMS) service.

In embodiments of this application, the terminal device or the network device includes a hardware layer, an operating system layer running on the hardware layer, and an application layer running on the operating system layer. The hardware layer includes hardware such as a central processing unit (CPU), a memory management unit (MMU), and a memory (which may also be referred to as a main memory). The operating system may be any one or more types of computer operating systems that implement service processing through a process, for example, a Linux operating system, a Unix operating system, an Android operating system, an iOS operating system, or a Windows operating system. The application layer includes applications such as a browser, an address book, word processing software, and instant messaging software. In addition, a structure of an execution body of a method provided in embodiments of this application is not particularly limited in embodiments of this application, provided that a program that records code of the method provided in embodiments of this application can be run to perform communication according to the method provided in embodiments of this application. For example, the execution body of the method provided in embodiments of this application may be the terminal device or the network device, or a functional module that can invoke and execute the program in the terminal device or the network device.

In addition, aspects or features of this application may be implemented as a method, an apparatus, or a product that uses standard programming and/or engineering technologies. The term “product” used in this application covers a computer program that can be accessed from any computer-readable component, carrier, or medium. For example, the computer-readable medium may include but is not limited to: a magnetic storage component (for example, a hard disk, a floppy disk or a magnetic tape), an optical disc (for example, a compact disc (CD), or a digital versatile disc (DVD)), or a smart card and a flash memory component (for example, an erasable programmable read-only memory (EPROM), a card, a stick, or a key drive). In various storage media described in this specification may represent one or more devices and/or other machine-readable media that are configured to store information. The term “machine-readable media” may include but is not limited to a radio channel, and various other media that can store, contain, and/or carry instructions and/or data.

It should be noted that quantities and types of network devices and terminal devices in the network architecture shown in FIG. 1A are merely an example, and embodiments of this application are not limited thereto. For example, more or fewer terminal devices that communicate with the network device may alternatively be included. For another example, more or fewer network devices that communicate with the terminal device may alternatively be included. For conciseness of description, this is not described one by one in the accompanying drawings.

In addition, in the network architecture shown in FIG. 1A, although the network device and the terminal device are shown, the application scenario may not be limited to including the network device and the terminal device. For example, the application scenario may further include a device configured to bear a virtualized network function. This is clear to a person skilled in the art, and details are not described herein.

For ease of understanding the method provided in this application, the following several points are first described.

First, for ease of description, the method provided in this application is described below by using interaction between a network device and a terminal device as an example. However, this should not constitute any limitation on the scope to which this application is applicable. A relay device may further assist in communication between the network device and the terminal device. Based on different networking forms, the relay device may implement single-hop forwarding (corresponding to a single-hop relay system), or may implement multi-hop forwarding (corresponding to a multi-hop relay system). This is not limited in this application.

Second, for ease of clearly describing technical solutions in embodiments of this application, words such as “first” and “second” are used in embodiments of this application to distinguish between same items or similar items that provide basically same functions or effects. For example, first sub-signaling and second sub-signaling are merely used to distinguish between different sub-signaling. A person skilled in the art may understand that “first”, “second”, and the like do not limit a quantity or an execution sequence.

Third, “sending” and “receiving” in embodiments of this application indicate signal transfer directions, for example, “sending information/data to A” and “sending information/data”, where “sending to A” and “sending” merely indicate a direction of information/data transmission, A is a destination, and “sending information/data to A” is not limited to sending on an air interface. “Sending information/data to A” includes directly sending information/data to A and indirectly sending information/data to A. Therefore, “sending information/data to A” may also be understood as “outputting information/data to A” by a communication interface of a processing unit. Similarly, “sending information/data” may also be understood as “outputting information/data”.

Similarly, “receiving information/data from A” and “receiving information/data” merely indicate a direction of information/data transmission. “From A” indicates that a source of the information/data is A. This includes directly receiving information/data from A and indirectly receiving information/data from A. Therefore, “receiving information/data from A” may also be understood as “inputting information/data from A” by a communication interface of a processing unit. Similarly, “receiving information/data from A” may also be understood as “inputting information/data”.

Fourth, in embodiments of this application, “indication” may include direct indication and indirect indication, or may include explicit indication and implicit indication. Information indicated by a piece of information (for example, the following indication information) is referred to as to-be-indicated information. In an embodiment, the to-be-indicated information may be indicated in a plurality of manners, for example, but not limited to, directly indicating the to-be-indicated information, for example, indicating the to-be-indicated information, an index of the to-be-indicated information, or the like. Alternatively, the to-be-indicated information may be indirectly indicated by indicating other information. There is an association relationship between the other information and the to-be-indicated information. Alternatively, only a part of the to-be-indicated information may be indicated, and the remaining part of the to-be-indicated information is known or pre-agreed on. For example, information may alternatively be indicated by using an arrangement sequence of pieces of information that are pre-agreed on (for example, predefined in a protocol), to reduce indication overheads to some extent. An indication manner is not limited in this application. It may be understood that, for a sender of the indication information, the indication information may indicate to-be-indicated information, and for a receiver of the indication information, the indication information may be for determining to-be-indicated information.

Fifth, “include” may indicate an inclusion relationship, or an equal relationship. For example, if A includes B, A may include other content in addition to B, or A and B are the same content.

Sixth, “at least one” means one or more, and “a plurality of” means two or more. “And/or” describes an association relationship between associated objects, and indicates that three relationships may exist. For example, A and/or B may indicate the following three cases: Only A exists, both A and B exist, and only B exists, where A and B may be in a singular form or a plural form. The character “/” generally indicates an “or” relationship between the associated objects. “At least one of the following items (pieces)” or a similar expression thereof refers to any combination of these items, including a single item (piece) or any combination of a plurality of items (pieces). For example, at least one of a, b, or c may indicate a, b, c, a and b, a and c, b and c, or a, b, and c, where a, b, and c may be single or plural.

Seventh, tables in embodiments of this application are merely examples. Values of information in the tables are merely examples, and other values may be configured. This is not limited in this application. The tables do not constitute a limitation on the protection scope of this application. For example, appropriate deformation and adjustment such as splitting and combination may be performed based on the foregoing tables. For another example, names of parameters shown in titles of the tables may alternatively be other names that can be understood by a communication apparatus, and values or representation manners of the parameters may alternatively be other values or representation manners that can be understood by the communication apparatus. For still another example, during implementation of the foregoing tables, another data structure, for example, an array, a queue, a container, a stack, a linear table, a pointer, a linked list, a tree, a graph, a structure, a class, a pile, or a hash table, may alternatively be used.

The following first provides definitions of technical terms that may occur in embodiments of this application. Terms used in embodiments of this application are merely used to explain embodiments of this application, and are not intended to limit this application.

1. An antenna port may be referred to as a port for short. One antenna port may be one physical antenna, or may be a weighted combination of a plurality of physical antennas. In embodiments of this application, the port may include a transmit port and a receive port. The transmit port may be understood as a virtual antenna identified by a receiving device, and may be an actual independent transceiver unit (transmitter receiver unit, TxRU), or a transmit antenna that can be spatially distinguished. One port may be preconfigured for each virtual antenna, each virtual antenna may be a weighted combination of a plurality of physical antennas, and each port may correspond to a reference signal (RS). Therefore, each port may be referred to as a port of a reference signal, and a reference signal of each port may be transmitted by using one or more frequency domain units. The receive port may be understood as a receive antenna of the receiving device. For example, in downlink transmission, the receive port may be a receive antenna of a terminal device.

In embodiments of this application, a total quantity of transmit ports of the terminal device may be denoted as N, and a total quantity of receive ports of a network device may be denoted as M. The transmit ports of the terminal device are grouped to obtain a plurality of transmit port groups, and a quantity of transmit port groups may be denoted as X. A quantity of first transmit port groups of the terminal device may be greater than or equal to 1 and less than or equal to X. This is not limited in this application. It may be understood that when the quantity of first transmit port groups is less than X, the first transmit port groups represent some transmit port groups.

A quantity of transmit ports in the first transmit port group may be denoted as NG. Quantities of transmit ports in all transmit port groups may be unequal or equal. If the quantities of transmit ports in all the transmit port groups are equal, X=N/NG. The following uses an example in which the total quantity N of transmit ports of the terminal device is 32. For example, the terminal device has a total of four transmit port groups: a transmit port group A, a transmit port group B, a transmit port group C, and a transmit port group D, and quantities of transmit ports in all the transmit port groups are equal. In this case, X=4, and NG=8, that is, each transmit port group includes eight transmit ports. Sequence numbers of transmit ports in the transmit port group A may be {1, 2, . . . , 7, 8}, sequence numbers of transmit ports in the transmit port group B may be {9, 10, . . . , 15, 16}, sequence numbers of transmit ports in the transmit port group C may be {17, 18, . . . , 23, 24}, and sequence numbers of transmit ports in the transmit port group D may be {25, 26, . . . , 31, 32}.

For another example, the terminal device has a total of four transmit port groups: a transmit port group A, a transmit port group B, a transmit port group C, and a transmit port group D, and quantities of transmit ports in all the transmit port groups are different. Sequence numbers of transmit ports in the transmit port group A may be {1, 2, 3, 4}, sequence numbers of transmit ports in the transmit port group B may be {5, 6, . . . , 15, 16}, sequence numbers of transmit ports in the transmit port group C may be {17, 18, 19, 20, 21}, and sequence numbers of transmit ports in the transmit port group D may be {22, 26, . . . , 31, 32}. In this way, when the first transmit port group is the transmit port group A, NG is equal to 4. When the first transmit port group is the transmit port group B, NG is equal to 12. When the first transmit port group is the transmit port group C, NG is equal to 5. When the first transmit port group is the transmit port group D, NG is equal to 11.

It should be understood that the foregoing is merely an example, and a sequence of transmit ports in a group is not limited in this application. For example, sequence numbers of the transmit ports in the transmit port group A may be {1, 9, 17, 25}, {1, 2, 15, 16}, or the like. In addition, a quantity of transmit port groups is not limited in this application. For example, 32 transmit ports of the terminal device may be divided into eight groups, and each group has four transmit ports.

In some feasible examples, the port may alternatively be an analog antenna (analog port) constructed by performing phase shifting on a physical antenna (physical port) through an analog phase shifter. A network architecture in which the analog port is constructed through the analog phase shifter may be referred to as a hybrid beamforming (HBF) connection architecture. The architecture may be a fully-connected structure (FCS) or a partially-connected structure (PCS). Each radio frequency (RF) channel of the FSC is connected to all ports. The PCS may also be referred to as a sub-connection structure, and each RF channel of the PCS is connected to one subarray. A structure corresponding to the PCS may be understood as a 1-drive-N sub-connection architecture, that is, one intermediate frequency channel is connected to some ports. N in 1-drive-N means a plurality of, and is irrelevant to the total quantity of transmit ports of the terminal device in this specification. A plurality of analog ports may be constructed by performing phase shifting on one physical port, thereby reducing a quantity of RF channels, and reducing hardware implementation complexity. A subarray connected to each RF channel may be referred to as an HBF subarray or an HBF analog domain subarray.

The following uses a 1-drive-N HBF sub-connection architecture as an example. Refer to FIG. 1B. As shown in FIG. 1B, the architecture may be divided into a baseband structure, an intermediate frequency structure, and a radio frequency structure based on a frequency band. A fully-connected manner may be used for ports in the baseband structure, and a sub-connection manner may be used for ports in the radio frequency structure. In this architecture, a quantity Ns of data streams may be less than or equal to a quantity NBB of baseband ports, and the quantity NBB of baseband ports may be equal to a quantity NIF of intermediate frequency channels. A digital weight WBB of a frequency mixer in the baseband structure may be equal to NBB*Ns, and an analog weight WRF of a frequency mixer in the radio frequency structure may be equal to Ns*Nps. Nps is a quantity of phase shifters in an independent power amplifier (PA) subgroup connected to each radio frequency channel, and Nps may be equal to a quantity NPA of radio frequency PAs. In FIG. 1B, there may be two phase shifters in an HBF subarray.

An adder in the baseband structure is configured to add frequency bands obtained by a plurality of frequency mixers. An intermediate frequency device in the intermediate frequency structure is configured to convert a frequency segment of a frequency band obtained by the adder into an intermediate frequency, and transmit the intermediate frequency to a digital-to-analog converter, so that the digital-to-analog converter converts digital electricity into analog electricity, and then transmits the analog electricity to the frequency mixer in the radio frequency structure. The frequency mixer in the radio frequency structure constructs an analog signal in a radio frequency segment through the analog phase shifter, and may amplify the analog signal through a power amplifier, and then transmit the analog signal to a physical port. A plurality of analog ports may be constructed. In this way, a quantity of RF channels can be reduced, thereby reducing hardware overheads.

2. A reference signal may also be referred to as a pilot signal, a reference sequence, or the like. In embodiments of this application, the reference signal is a known signal that is provided by a transmit end for a receive end for channel estimation or channel sounding. In an embodiment, the reference signal includes at least one of an SRS, a channel state information reference signal (CSI-RS), a demodulation reference signal (DMRS), a phase tracking reference signal (PT-RS), and the like. This is not limited herein.

The SRS is used for uplink channel measurement, time-frequency synchronization, beam management, and the like. The CSI-RS is used for downlink channel measurement, obtaining downlink channel state information, beam management, radio resource management (RRM) measurement/radio link monitoring (RLM) measurement and refined time-frequency tracking, mobility management, rate matching, and the like. The DMRS is used for channel estimation to demodulate a corresponding physical channel, and the PT-RS is used for phase noise tracking and compensation.

3. A time-frequency resource may include a time domain resource, a frequency domain resource, a resource element (RE), and the like. A unit of the time domain resource may include a frame, a subframe, a slot, a sub-slot, a mini-slot, a symbol, a transmission time interval (TTI), and the like. The TTI is a basic time unit for dynamically scheduling a resource, and each dynamic scheduling is a TTI. Generally, one TTI is 1 ms. A unit of the frequency domain resource may include a subcarrier, a subcarrier spacing, a bandwidth, a resource block (RB), a resource block group (RB group, RBG), a bandwidth part (BWP), a precoding resource block group (PRG), and the like. In embodiments of this application, the unit of the time domain resource may be referred to as a time domain unit. The unit of the frequency domain resource may be a frequency domain unit, and a total quantity of frequency domain units may be denoted as P. For example, when the frequency domain unit is a subcarrier, P subcarriers are configured.

An RE location of the reference signal may be configured by the network device, and obtained by the terminal device based on configured information, or the RE location is obtained by the terminal device by performing blind detection on the reference signal. In an embodiment, there may be a correspondence between the RE location of the reference signal and a port number.

Because content of a frequency domain and a space domain may change with a time domain, channel information of a time domain unit may be channel coefficients of a communication system in time domain, frequency domain, and space domain. The time domain unit may be the unit of the time domain resource, for example, the TTI. In an embodiment, the channel information of the time domain unit may be obtained through historical measurement or offline learning. For example, after a UE accesses a RAN, the RAN may indicate the UE to feed back channel information of a plurality of TTIs.

4. An OCS is a weight matrix including a plurality of orthogonal weight vectors. Every two row vectors (or column vectors) in the weight matrix are orthogonal to each other (a product is 0), and an element in each row vector (or column vector) represents a weight that needs to be sent through each port. Code division multiplexing (CDM) can be implemented by using the OCS, and communication efficiency can be improved. The OCS may include an orthogonal cover code (OCC) in an existing communication system.

The row vector or the column vector in the OCS may also be referred to as an orthogonal code. In an embodiment, the orthogonal code may include a discrete transform (DFT) code, a Hadamard, and the like, where the Hadamard may also be referred to as a Walsh code. For example, an OCS corresponding to the DFT code is denoted as a matrix A, and an OCS corresponding to the Hadamard is denoted as a matrix B. In this case, the matrix A and the matrix B may be shown as follows:

$$A = [ \begin{matrix}1 & 1 & 1 & 1 \\ 1 & - 1 j & - 1 & 1 j \\ 1 & - 1 & 1 & - 1 \\ 1 & 1 j & 1 & - 1 j\end{matrix} ] ,$$

$$and$$

$$B = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] .$$

5. Matrix decomposition is to decompose one matrix into two or more matrices, so that the matrices obtained through decomposition can be multiplied to obtain the original matrix. The matrix decomposition may include singular value decomposition (SVD), eigen value decomposition (EVD), and the like. This is not limited herein. The EVD requires that a decomposed matrix is a square matrix. The SVD is a generalization of the EVD on any matrix. The SVD may be used for row dimension reduction and column dimension reduction. The SVD is widely applied in data compression, a recommendation system, and semantic analysis. SVD decomposition may be performed on a matrix M according to Formula (1):

$$M = U \sum {V}^{*} \qquad ( 1 )$$

M is an m*n-order matrix. U is an m*n-order unitary matrix, and Σ is a positive semi-definite m*n-order diagonal matrix. V* is a conjugate transposition of V, and is an n*n-order unitary matrix. An element Ei on a diagonal of 2 is a singular value of M. Columns of U form a set of orthogonal “input” or “analysis” base vectors of M. These vectors are feature vectors of MM*. Columns of V form a set of orthogonal “output” base vectors of M. These vectors are feature vectors of M*M.

6. Subspace and projection, and subspace projection algorithm.

For example, there is an m*n matrix A, where A={a₁, a₂, . . . , aₙ}. When n<m, n column vectors of the matrix A form one subspace in an m-dimensional space. If a₁, a₂, . . . , and aₙ are linearly uncorrelated, a linear combination p=x₁a₁+ . . . +xₙaₙ is expected to be found, to cause p to be closest to a given vector b. In this case, a combination closest to b in a plurality of subspaces corresponding to the n column vectors of the matrix A may be referred to as a projection of the vector b in the subspace (column space) of the matrix A.

In embodiments of this application, an algorithm for obtaining a projection of a subspace is referred to as a subspace projection algorithm for short. The subspace projection algorithm is used for compression, so that indication overheads of a reference signal can be reduced. A type of the subspace projection algorithm is not limited in this application, for example, an orthogonal triangle (QR) decomposition algorithm, and a minimum noise-based search algorithm may be used. The QR decomposition algorithm is to divide a matrix into a normal orthogonal matrix Q and an upper triangular matrix R. The minimum noise-based search algorithm may be used to select an orthogonal vector in a subspace.

7. Selection matrix, base matrix, kernel matrix, and observation matrix.

The selection matrix may be used to select a column in another matrix. Each column in the selection matrix may include an element of 1, and the remaining values are 0. A form of the selection matrix C may be represented as follows:

$$C = [ \begin{matrix}0 & … & 1 & … & 0 & … & 0 & … & 0 \\ 0 & … & 0 & … & 1 & … & 0 & … & 0 \\ & & & & … & & & & \\ 0 & … & 0 & … & 0 & … & 1 & … & 0\end{matrix} ] .$$

The base matrix is a full-rank submatrix, and column vectors are linearly independent. In embodiments of this application, the base matrix is a right singular matrix obtained by performing SVD decomposition on a channel matrix. The kernel matrix is a matrix obtained by multiplying all matrices except the base matrix that are obtained by performing SVD decomposition on the channel matrix. The observation matrix is a matrix including channel coefficients obtained after the network device receives a reference signal and removes the reference signal.

In an uplink channel estimation solution, the terminal device may send a reference signal, for example, an SRS, to the network device. After receiving the reference signal from the terminal device, the network device may determine a channel matrix based on the reference signal. The channel matrix may indicate channel state information of a transmit port, a receive port, and a scheduled frequency domain unit. In this way, in some possible design solutions, when sending a reference signal, the terminal device needs to send the reference signal on a frequency domain resource that can be used to send the reference signal and a transmit port that can be used to send the reference signal.

An example in which the SRS is implemented by using a comb-2 comb structure and four cyclic shifts (CSs) is used. It is assumed that the terminal device sends SRSs on eight transmit ports (a transmit port 0 to a transmit port 7), and invoked frequency domain resources include a frequency domain unit 0 to a frequency domain unit 1319, where each terminal device occupies one time domain symbol, and the following time domain symbol is referred to as a symbol for short. In this case, the transmit ports of the terminal device may be divided into two groups. For example, the transmit port 0 to the transmit port 3 are one group of transmit ports, and the transmit port 4 to the transmit port 7 are one group of transmit ports. Different groups of transmit ports occupy different frequency domain resources, and SRS sequences between different groups are different.

For example, as shown in Table 1, if each TTI, for example, any one of a TTI 1 to a TTI 6, includes a symbol 0 to a symbol 6, the symbol 5 is a guard interval (GI), and a symbol occupied by the terminal device is the symbol 6. An SRS sequence 1 is multiplexed on the transmit port 0 to the transmit port 3 of the terminal device, and frequency domain units for sending a reference signal include frequency domain units 2n-1. An SRS sequence 2 is multiplexed on the transmit port 4 to the transmit port 7 of the terminal device, and frequency domain units for sending a reference signal include frequency domain units 2n. Values of n are 1, . . . , and 658.

TABLE 1

| Frequency | | | | | | | | | |
|---|---|---|---|---|---|---|---|---|---|
| domain | TTI 1 | | | | | TTI 6 | | | |
| unit index | Symbol 0 | . . . | Symbol 5 | Symbol 6 | . . . | Symbol 0 | . . . | Symbol 5 | Symbol 6 |

| | | | | | | |
|---|---|---|---|---|---|---|
| 0 | . . . | GI | | | GI | |
| 1 | | | Transmit | | | Transmit |
| | | | ports 0 to 3 | | | ports 0 to 3 |
| 2 | | | Transmit | | | Transmit |
| | | | ports 4 to 7 | | | ports 4 to 7 |
| . . . | | | Transmit | . . . | | Transmit |
| | | | ports 0 to 3 | | | ports 0 to 3 |
| | | | Transmit | | | Transmit |
| | | | ports 4 to 7 | | | ports 4 to 7 |
| | | | . . . | | | . . . |
| | | | Transmit | | | Transmit |
| | | | ports 0 to 3 | | | ports 0 to 3 |
| | | | Transmit | | | Transmit |
| | | | ports 4 to 7 | | | ports 4 to 7 |
| 1317 | | | Transmit | | | Transmit |
| | | | ports 0 to 3 | | | ports 0 to 3 |
| 1318 | | | Transmit | | | Transmit |
| | | | ports 4 to 7 | | | ports 4 to 7 |
| 1319 | | | | | | |

Each group of transmit ports is transformed to a time domain through cyclic shifts (CSs) for resolution, and different cyclic shifts in one group of transmit ports correspond to different transmit ports. The reference signal on the transmit port may be for determining channel state information corresponding to a dimension of the transmit port. Channel state information corresponding to a frequency domain may be restored through fast Fourier transform (FFT) interpolation.

However, with the development of wireless communication technologies, a size of an antenna greatly increases. If the foregoing solution is used, when a quantity of transmit ports is large, overheads of the reference signal used for channel estimation also increase greatly. For example, when the SRS is implemented by using the comb-2 comb structure and the four cyclic shifts (CSs), if there are 32 transmit ports for sending reference signals, where in the 32 transmit ports, a transmit port 0 to a transmit port 3 are one group of transmit ports, a transmit port 4 to a transmit port 7 are one group of transmit ports, a transmit port 8 to a transmit port 11 are one group of transmit ports, a transmit port 12 to a transmit port 15 are one group of transmit ports, a transmit port 16 to a transmit port 19 are one group of transmit ports, a transmit port 20 to a transmit port 23 are one group of transmit ports, a transmit port 24 to a transmit port 27 are one group of transmit ports, and a transmit port 28 to a transmit port 31 are one group of transmit ports, time domain symbols for sending the reference signals in each TTI are shown in Table 2 below. As a result, the time domain symbols occupied by the reference signals are four times of the time domain symbols in the case of the eight antenna ports.

TABLE 2

| Frequency | | | | | | | |
|---|---|---|---|---|---|---|---|
| domain unit | TTI | | | | | | |
| index | Symbol 0 | Symbol 1 | Symbol 2 | Symbol 3 | Symbol 4 | Symbol 5 | Symbol 6 |
| 0 | | | GI | | | | |
| 1 | | | | Transmit | Transmit | Transmit | Transmit |
| | | | | ports 0 to | ports 8 to | ports 16 | ports 24 |
| | | | | 3 | 11 | to 19 | to 27 |
| 2 | | | | Transmit | Transmit | Transmit | Transmit |
| | | | | ports 4 to | ports 12 | ports 20 | ports 28 |
| | | | | 7 | to 15 | to 23 | to 31 |
| . . . | | | | Transmit | Transmit | Transmit | Transmit |
| | | | | ports 0 to | ports 8 to | ports 16 | ports 24 |
| | | | | 3 | 11 | to 19 | to 27 |
| | | | | Transmit | Transmit | Transmit | Transmit |
| | | | | ports 4 to | ports 12 | ports 20 | ports 28 |
| | | | | 7 | to 15 | to 23 | to 31 |
| | | | | . . . | | . . . | . . . |
| | | | | Transmit | Transmit | Transmit | Transmit |
| | | | | ports 0 to | ports 8 to | ports 16 | ports 24 |
| | | | | 3 | 11 | to 19 | to 27 |
| | | | | Transmit | Transmit | Transmit | Transmit |
| | | | | ports 4 to | ports 12 | ports 20 | ports 28 |
| | | | | 7 | to 15 | to 23 | to 31 |
| 1317 | | | | Transmit | Transmit | Transmit | Transmit |
| | | | | ports 0 to | ports 8 to | ports 16 | ports 24 |
| | | | | 3 | 11 | to 19 | to 27 |
| 1318 | | | | Transmit | Transmit | Transmit | Transmit |
| | | | | ports 4 to | ports 12 | ports 20 | ports 28 |
| | | | | 7 | to 15 | to 23 | to 31 |
| 1319 | | | | | | | |

In addition, in the channel estimation solution, in each TTI, for all of different SRS sequences, reference signals need to be sent on frequency domain units allocated to different transmit port groups based on a comb structure. As a result, a large quantity of frequency domain resources are occupied for reference signal sending. Therefore, how to reduce overheads of the reference signal is an urgent problem to be resolved.

Based on this, this application provides a communication method. In the method, an OCS is used to construct a channel matrix of a transmit port group, so that code division multiplexing can be implemented. In addition, the channel matrix is further compressed, so that a measurement delay can be reduced, overheads of a reference signal can be reduced, a transmit power and an SNR of communication transmission can be increased, and channel estimation accuracy can be improved.

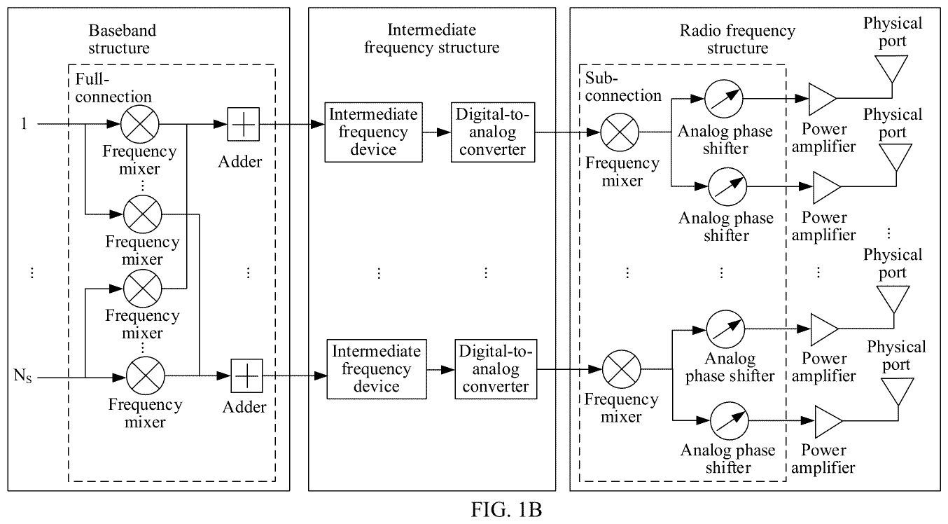

For a diagram of a reference signal processing method provided in this application, refer to FIG. 2. In FIG. 2, an example in which a reference signal is an SRS, a frequency domain unit is a subcarrier, a total quantity of subcarriers may be denoted as P, a time domain unit is a TTI, and compression includes SVD decomposition and QR decomposition is used for description. The method is applicable to an application scenario of uplink communication. A port of a terminal device may be referred to as a transmit port, and a total quantity of transmit ports is N. A port of a network device may be referred to as a receive port, and a total quantity of receive ports is M. As shown in FIG. 2, the method includes operation S201 to operation S208.

S201: The network device performs matrix concatenation on a matrix or tensor H including the N transmit ports of the terminal device, the M receive ports of the network device, and P frequency domain units, to obtain a vector H1.

An x-axis of the matrix or tensor H represents a frequency of a subcarrier. A y-axis represents a quantity of transmit ports of the terminal device, and a z-axis represents a quantity of receive ports of the network device. The matrix or tensor H may be considered as a three-dimensional matrix or tensor including dimensions respectively corresponding to a port of the terminal device, a port of the network device, and a frequency domain. The vector H1 may be used as an MN*P two-dimensional complex matrix, and is a concatenated matrix including channel coefficients. Each element in the vector H1 represents a channel of an n^{th} transmit port of the terminal device on an m^{th} receive port of the network device on a p^{th} subcarrier, where p∈P, n∈N, and m∈M.

It should be noted that, in FIG. 2, the vector H1 is obtained by splicing two dimensions corresponding to the transmit port of the terminal device and the receive port of the network device into a new dimension when a dimension of the frequency domain in the matrix or tensor H remains unchanged. Actually, in an uplink communication scenario, the vector H1 may alternatively be obtained by splicing a dimension of the transmit port of the terminal device and a dimension of the frequency domain into a new dimension when a dimension of the receive port of the network device in the matrix or tensor H remains unchanged, or may be obtained by splicing the dimension of the receive port of the network device and the dimension of the frequency domain into a new dimension when the dimension of the transmit port of the terminal device in the matrix or tensor H remains unchanged. In a downlink communication scenario, the vector H1 may be obtained by splicing the other two dimensions into a new dimension when one of the three dimensions of the receive port of the terminal device, the transmit port of the network device, and the frequency domain remains unchanged.

S202: The network device performs SVD decomposition on the vector H1, to obtain a matrix G1 and a matrix V1.

The matrix G1 is an MN*R1 complex matrix. The matrix V1 is an R1*P complex matrix, R1 is a rank of the matrix obtained through the SVD decomposition, and represents R1 orthogonal subcarriers in the P subcarriers. The matrix V1 may be a base matrix, and may be understood as a matrix related to a large-scale parameter of a channel. The large-scale parameter of the channel includes a Doppler delay of the channel, an angle of departure and an angle of arrival of the channel, and the like. The matrix G1 may be a kernel matrix, and may be understood as a matrix related to time T.

S203: The network device performs QR decomposition on the matrix V1 to obtain a matrix V1_{sub} and a matrix C1.

The matrix V1_{sub} is an R1*R1 complex matrix, and includes R1 orthogonal columns in the matrix V1. The matrix V1_{sub} may be referred to as an orthogonal base matrix. A quantity of columns of the matrix C1 is equal to a quantity of rows (or a quantity of columns) of the matrix V1_{sub} and a quantity of rows of the matrix V1, and all the quantities are R1. A quantity of rows of the matrix C1 is equal to a quantity of columns of the matrix V1 and is equal to P. The matrix C1 may be a selection matrix. A location of a row in which an element whose value is 1 is located represents a location of a transmit port of an SRS in frequency domain, and may indicate a mode of a reference signal in frequency domain, for example, a mode like beam management, a codebook, a non-codebook, or antenna switching. The matrix V1_{sub} is equivalent to columns selected from the matrix V1 through the matrix C1, so that a sequence corresponding to each row of the matrix V1 represents a position of a frequency domain in which an SRS resource is located and a location of the SRS resource on a transmit port. In an embodiment, all ports of the terminal device have a same frequency domain mode.

S204: The network device converts, into a vector H2, a matrix or tensor H0 including the N transmit ports of the terminal device, the M receive ports of the network device, and R1 frequency domain units that are selected based on the matrix C1, converts the vector H2 into NG sub-channel vectors, and divides the N transmit ports of the terminal device into X transmit port groups based on the NG sub-channel vectors.

Each of the NG sub-channel vectors (for example, H2_sub1 and H2_subNG) includes channel coefficients of a transmit port in each transmit port group on all receive antennas and subcarriers. The matrix or tensor H0 may be understood as a partial matrix or tensor obtained through selection from the dimension of the frequency domain of the matrix or tensor H. After the selection, a quantity of subcarriers corresponding to frequency domain is R1, and the quantity of transmit ports of the terminal device and the quantity of receive ports of the network device remain unchanged. A quantity of rows of the vector H2 is NMR1, and a quantity of columns of the vector H2 is 1. The vector H2 may be considered as a one-dimensional column matrix obtained by splicing the three dimensions of the transmit port, the receive port, and the frequency domain.

A quantity NG of sub-channel vectors (or a quantity NG of transmit ports in a transmit port group), a quantity X of transmit port groups, and a transmit port group division method are not limited in this application. NG may be an integer greater than 1, for example, 2, 4, or 16. A product of X and NG may be equal to the total quantity N of transmit ports. In a method for dividing a plurality of sub-channel vectors, NG transmit ports with close sequence numbers may be used as one sub-channel vector based on a sequence of sequence numbers. Therefore, when NG is 2, transmit ports corresponding to sequence numbers 1 and 2 may be used as one sub-channel vector, transmit ports corresponding to sequence numbers 3 and 4 may be used as one sub-channel vector, and the like. In a method for dividing a plurality of sub-channel vectors, alternatively, NG close transmit ports may be used as one sub-channel vector based on a sequence of sequence numbers and parity of the sequence numbers. Therefore, when NG is 2, transmit ports corresponding to sequence numbers 1 and 3 may be used as one sub-channel vector, transmit ports corresponding to sequence numbers 2 and 4 may be used as one sub-channel vector, and the like.

In the transmit port group division method, one or more transmit ports may be randomly selected from each of a plurality of sub-channel vectors to form one transmit port group, one or more transmit ports may be selected from each of the plurality of sub-channel vectors based on a sequence number to form one transmit port group, transmit ports having a spatial association are selected from each of the plurality of sub-channel vectors to form one transmit port group, or the like.

The following uses an example in which one transmit port is selected from each of the plurality of sub-channel vectors based on a sequence number to form one transmit port group. For example, if N is 32 and NG is 2, the vector H2 may be divided into two sub-channel vectors (H2_sub₁ and H2_sub₂). The sub-channel vector H2_sub₁ may include transmit ports whose sequence numbers are 1 to 16, and the sub-channel vector H2_sub₂ may include transmit ports whose sequence numbers are 17 to 32. Then, transmit ports corresponding to sequence numbers 1 and 17 may be used as one group, transmit ports corresponding to sequence numbers 2 and 18 may be used as one group, and the like, so that the transmit ports are evenly allocated in the two sub-channel vectors, and the 32 transmit ports of the terminal device may be divided into 16 transmit port groups.

It should be understood that the transmit port group division method is merely an example. Actually, the transmit ports may alternatively be divided based on another division method. For example, transmit ports corresponding to sequence numbers 1 and 32 are used as one group, and transmit ports corresponding to sequence numbers 2 and 31 are used as one group. This is not limited herein.

In an HBF architecture, an analog phase shifter is used, to reduce a quantity of RF channels. However, there is a large quantity of actual physical antenna ports. Consequently, a large quantity of frequency domain resources are also occupied for reference signal sending. In the HBF architecture, code division multiplexing may also be implemented by using a method for constructing a channel matrix of a transmit port group by using an OCS, and division of a transmit port group may be determined by using an HBF subarray. For example, each transmit port group includes at least one transmit port in each HBF subarray; or each HBF subarray is used as one transmit port group.

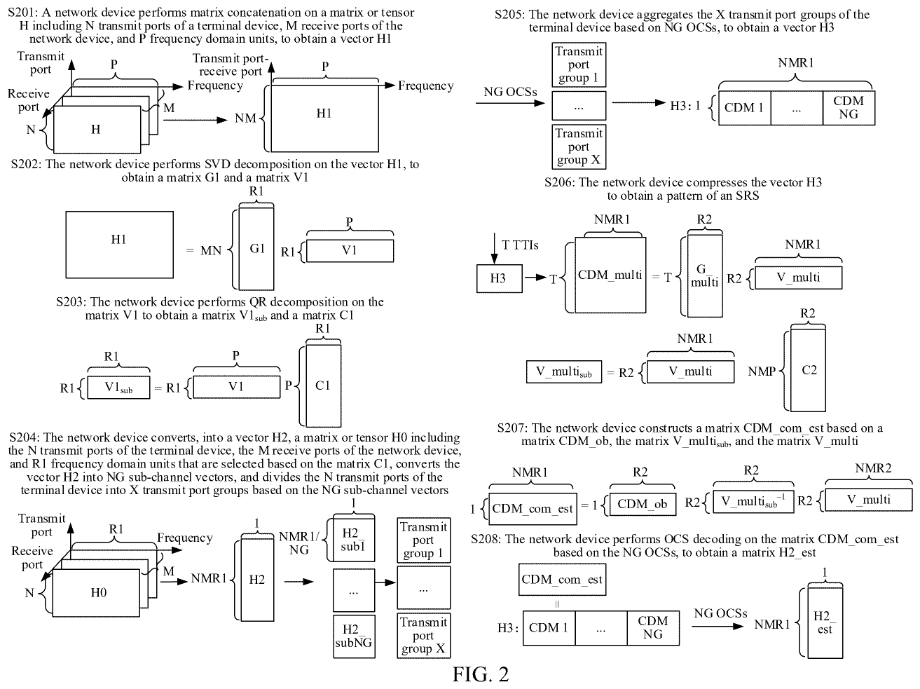

For example, FIG. 3A and FIG. 3B each are a diagram of an antenna port group division method according to this application. As shown in FIG. 3A, each transmit port group includes one transmit port in each HBF subarray. As shown in FIG. 3B, each transmit port group is an HBF subarray.

S205: The network device aggregates the X transmit port groups of the terminal device based on NG OCSs, to obtain a vector H3.

An OCS may include the foregoing Hadamard or DFT code, or another orthogonal code that is not involved in this specification. A quantity NG of orthogonal codes in the OCS is not limited in this application. For example, if NG=2 and N=32, there are 16 transmit port groups and two OCSs (for example, an OCS 1 and an OCS 2), and each transmit port group includes two transmit ports. The 16 transmit port groups are separately processed by using the OCS 1 and the OCS 2, and vectors that are in orthogonal code domain and that correspond to two transmit ports in each transmit port group may be obtained, for example, CDM 1 includes two transmit ports in a transmit port group 1 and a vector corresponding to the OCS 1, and CDM NG includes two transmit ports in a transmit port group 2 and a vector corresponding to the OCS 2. Obtained vectors are concatenated to form the vector H3.

The vector H3 includes CDM 1, CDM n, and CDM NG, and may be used as a one-dimensional row vector in orthogonal code domain. n is an integer greater than 1 and less than NG. When NG=2, CDM n=CDM NG. A size of the vector H3 is the same as a size of the original channel vector H2, but each column corresponds to a combination of a transmit port group and an orthogonal code rather than a transmit port, and a quantity of columns is NMR1.

S206: The network device compresses the vector H3 to obtain an SRS pattern.

In an embodiment, operation S206 may include: The network device concatenates, based on channel information of T time domain units, vectors that correspond to the vector H3 and that are in the T time domain units to obtain a matrix CDM_multi; and the network device performs SVD decomposition on the matrix CDM_multi to obtain a matrix G_multi and a matrix V_multi; and performs QR decomposition on the matrix V_multi to obtain a matrix V_multi_{sub} and a matrix C2.

T may be an integer greater than 1, for example, 50 or 100. T is not limited in this application. For the SVD decomposition, refer to the descriptions in operation S202, and for the QR decomposition, refer to the descriptions in operation S203. A quantity of columns of the matrix G_multi, a quantity of rows of the matrix V_multi, and a quantity of columns of the matrix C2 are equal, and are R2. A quantity of rows of the matrix G_multi is T, and the matrix CDM_multi and the matrix G_multi may be considered as matrices related to time T. A quantity of columns of the matrix CDM_multi is equal to a quantity of columns of the matrix V_multi and a quantity of rows of the matrix C2, and is NMR1. The matrix V_multi_{sub} obtained in operation S206 represents the SRS pattern used by the terminal device, and each column in the matrix V_multi_{sub} includes two pieces of information of the SRS pattern: a sequence number of an OCS and a sequence number of a transmit port group. The OCS does not need to be solved to obtain a channel on each transmit port.

The terminal device may send an SRS through the compressed matrix V_multi_{sub} in orthogonal code domain. After the network device receives the SRS, the network device may first perform operation S207: Construct a matrix CDM_com_est based on a matrix CDM_ob, the matrix V_multi_{sub}, and the matrix V_multi. Then, operation S208 is performed: Perform OCS decoding on the matrix CDM_com_est based on the NG OCSs to obtain a matrix H2_est.

The matrix CDM_ob may be an observation matrix, and is a matrix including channel coefficients obtained by removing a reference signal after the network device receives the reference signal sent based on operation S206. For a method for constructing the matrix CDM_com_est, refer to FIG. 2. The matrix CDM_com_est is equal to a product of the matrix CDM_ob, an inverse matrix (V_multi_{sub}⁻¹) of the matrix V_multi_{sub}, and the matrix V_multi. The matrix CDM_com_est may be understood as a channel matrix in CDM domain, and the inverse matrix (V_multi_{sub}⁻¹) of the matrix V_multi_{sub} is multiplied by the matrix V_multi_{sub} to obtain an identity matrix. A quantity of rows of the inverse matrix (V_multi_{sub}⁻¹) of the matrix V_multi_{sub} is equal to a quantity of columns of the inverse matrix (V_multi_{sub}⁻¹) of the matrix V_multi_{sub}, and the quantities are equal to a quantity of columns of CDM_ob and a quantity of rows and a quantity of columns of the matrix V_multi, and all the quantities are R2. A quantity of columns of the matrix CDM_com_est is NMR1, and a quantity rows of the matrix CDM_com_est is 1. The matrix CDM_com_est may be understood as the vector H3. The matrix H2_est obtained by performing OCS decoding on the matrix CDM_com_est based on the NG OCSs may be understood as a one-dimensional matrix including all the transmit ports of the terminal device, all the receive ports of the network device, and a frequency domain resource, to implement channel restoration.

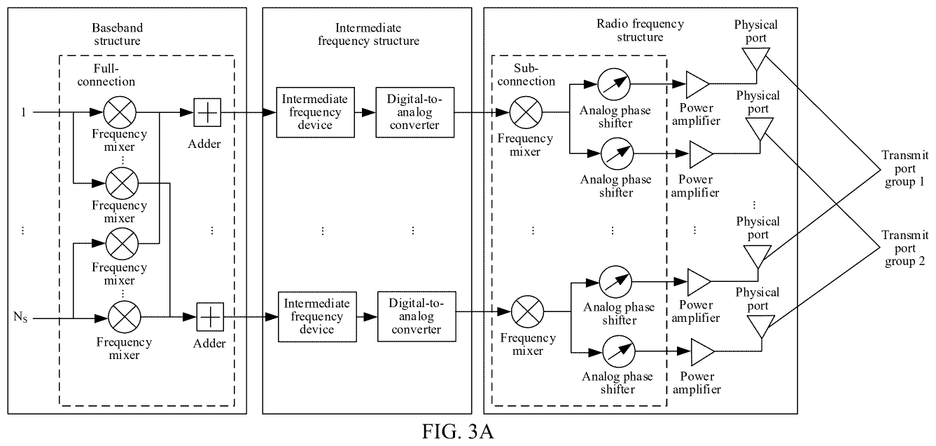

It may be understood that, according to the method shown in FIG. 2, a reference signal is sent through an OCS using a transmit port group. For a pattern of the reference signal, respectively refer to FIG. 4A to FIG. 4D. FIG. 4A to FIG. 4D each show a pattern of a reference signal obtained through simulation by using a 10 gigahertz-urban macrocell-non-line of sight (10G-Urban Macrocell-non-line of sight, 10G-UMA-NLOS) channel model. A cluster delay line of the 10G-UMA-NLOS model is a type A (cluster delay line-A type, CDL-A) channel, the channel is NLOS, a reference signal is an SRS, and a quantity T of time domain units is 100. For other simulation parameters, refer to Table 3. For group parameters of transmit ports, refer to Table 4. In Table 3, λ represents a wavelength of a carrier, dH represents a spacing between horizontal antenna elements, and dV represents a spacing between vertical antenna elements. m, n, and p are respectively a quantity of horizontal antennas, a quantity of vertical antennas, and a quantity of polarized ports of a device.

TABLE 3

| Parameter | Value |
|---|---|
| Application scenario | One network device and one terminal device |
| Carrier frequency | 10 GHz, 30 KHz SCS |
| Bandwidth | 16 RB |
| Channel | NLOS |
| Port configuration of | 32: (m, n, p) = (4, 4, 2); and (dH, dV) = |
| the terminal device | (0.5, 0.5)λ |
| Port configuration of | 1024: (m, n, p) = (8, 64, 2); and (dH, dV) = |
| the network device | (0.5, 0.5)λ |
| Standard channel | 460 paths: 23 clusters, and 20 rays |

TABLE 4

| | Quantity | | |
|---|---|---|---|
| | NG of | | |
| | transmit | | |
| Quantity | ports | | Quantity |
| X of | in each | | of REs |
| transmit | transmit | | needed |
| port | port | Sequence number of a transmit | for |
| groups | group | port in a transmit port group | transmission |
| 32 | 1 | {k}, where k ∈ | 12 |
| | | [1, 2, . . . , 32] | |
| 16 | 2 | {k, N + 16}, where k ∈ | 11 |
| | | [1, 2, . . . , 16] | |
| 8 | 4 | {k, k + 1, k + 2, k + 3}, | 11 |
| | | where k ∈ [1, 5, . . . , 29] | |
| 1 | 32 | {1, 2, . . . , 32} | 12 |

In Table 4, there are 32 transmit ports. The quantity of REs needed for transmission herein is a quantity of REs needed for sending a reference signal after a transmit port group and an OCS are combined, and may be a frequency domain resource or a time domain resource. If the quantity X of transmit port groups is equal to 32, the quantity NG of transmit ports in each transmit port group is equal to 1, and sequence numbers of transmit ports from 1 to 32 each belong to one transmit port group. If the quantity X of transmit port groups is equal to 16, the quantity NG of transmit ports in each transmit port group is equal to 2, a difference between sequence numbers of two transmit ports in each transmit port group may be 16, and a smallest sequence number of a transmit port in a transmit port group is any one of 1 to 16. For example, sequence numbers of transmit ports in the transmit port groups may be {1, 17}, {2, 18}, . . . , and {16, 32}.

If the quantity X of transmit port groups is equal to 8, the quantity NG of transmit ports in each transmit port group is equal to 4, a difference between a largest sequence number and a smallest sequence number in sequence numbers of four transmit ports in a transmit port group may be 4, and a difference between sequence numbers of transmit ports at a same location in the eight transmit port groups may be a multiple of 4. For example, sequence numbers of transmit ports in the transmit port groups may be {1, 2, 3, 4}, {5, 6, 7, 8}, . . . , and {29, 30, 31, 32}.

If the quantity X of transmit port groups is equal to 1, the quantity NG of transmit ports in each transmit port group is equal to 32, and sequence numbers of transmit ports from 1 to 32 all belong to one transmit port group, that is, sequence numbers of the transmit ports in the transmit port group are {1, 2, . . . , 32}.

As shown in FIG. 4A, when NG=1, each RE location has one port for SRS sending. As shown in FIG. 4B, when NG=2, each RE location has two ports for SRS sending, that is, a group used for SRS sending on each RE includes 2 ports. As shown in FIG. 4C, when NG=4, each RE location has four ports for SRS sending, that is, a group used for SRS sending on each RE includes 4 ports. As shown in FIG. 4D, when NG=32, each RE location has 32 ports for SRS sending, that is, a group used for SRS sending on each RE includes 32 ports. It can be learned that a larger quantity of NGs indicates a larger quantity of transmit ports that can be used to send a reference signal, and sending a reference signal in a unit of a transmit port group can improve an SNR of communication transmission.

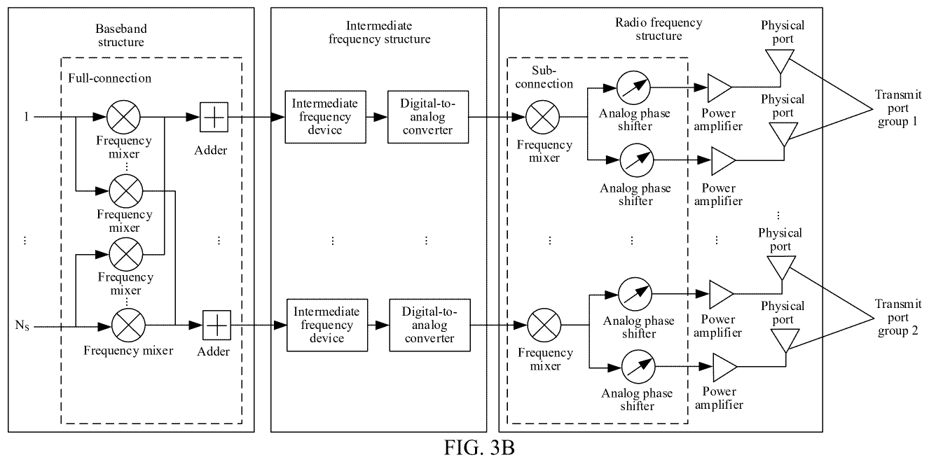

For example, FIG. 5 is a diagram of simulation of average downlink spectral efficiency when NG=1, 2, 4, or 32 in the simulation model shown in Table 3. A value corresponding to a box is parallel average spectral efficiency, and a value corresponding to a line segment is standard average downlink spectral efficiency. As shown in FIG. 5, a smaller NG indicates lower average downlink spectral efficiency. It can be learned that sending a reference signal by using a transmit port group constructed by using an OCS can improve an SNR of communication transmission.

It should be noted that, in FIG. 2 and FIG. 4A to FIG. 4D, an uplink communication scenario in which a reference signal is sent to the network device is used as an example, and the reference signal is an SRS. Actually, the method may alternatively be applied to a downlink communication scenario. For example, the reference signal is a CSI-RS.

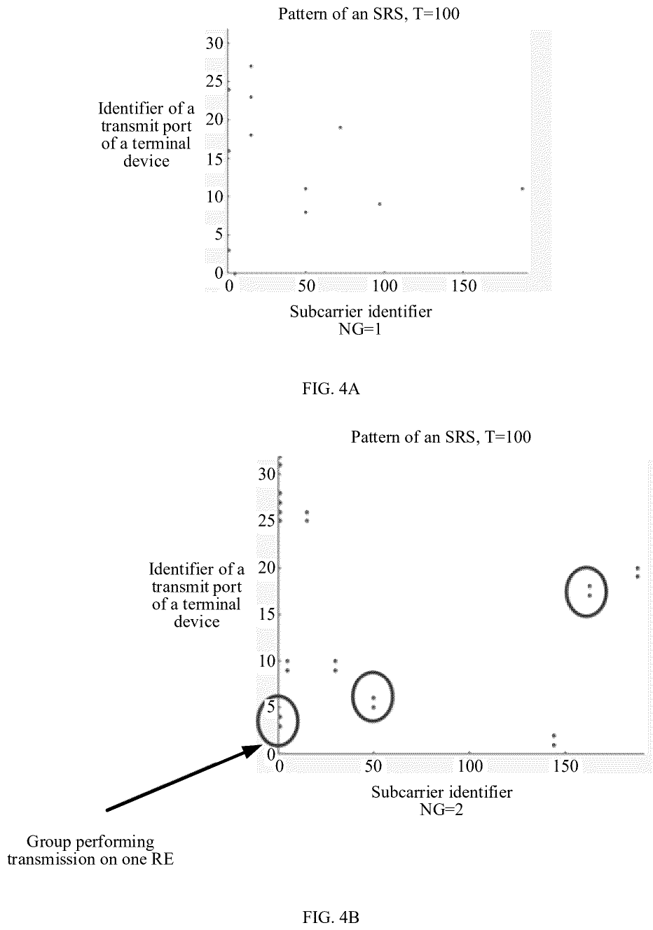

In an embodiment, FIG. 6 is a diagram of interaction of a communication method according to an embodiment of this application. An application scenario of uplink communication is used as an example in the communication method. Actually, the communication method may alternatively be applied to a downlink communication scenario. In the downlink communication scenario, after determining configuration information, a network device sends a reference signal to a terminal device based on the configuration information. The configuration information may be sent by the network device to the terminal device, or the network device may not send the configuration information to the terminal device. The terminal device performs channel estimation on the received reference signal.

The terminal device in this embodiment may be the terminal device in the foregoing communication system. In this embodiment, a function performed by the terminal device may be performed by an apparatus (for example, a chip, a chip system, or a circuit) in the terminal device, or may be an apparatus that can be used in combination with the terminal device. The network device in this embodiment may be the network device in the foregoing communication system. In this embodiment, a function performed by the network device may be performed by an apparatus (for example, a chip, a chip system, or a circuit) in the network device, or may be an apparatus that can be used in combination with the network device.

As shown in FIG. 6, the communication method may include but is not limited to the following operation S601 and operation S602.

S601: The network device sends configuration information to the terminal device. Correspondingly, the terminal device receives the configuration information from the network device.

The configuration information indicates to send a reference signal through a first transmit port group using a first OCS, so that code division multiplexing can be implemented. The configuration information includes a configuration of the first transmit port group and/or a configuration of the first OCS. For definitions of the reference signal, a transmit port group, the first transmit port group, and an OCS, refer to the foregoing descriptions. Details are not described herein again. A quantity of first transmit port groups is less than or equal to X, where X is a total quantity of transmit port groups of the terminal device. A quantity of first OCSs is less than or equal to NG, where NG is a total quantity NG of transmit ports in the first transmit port group. When the quantity of first transmit port groups is equal to X, the quantity of first OCSs is less than NG. When the quantity of first OCSs is equal to NG, the quantity of first transmit port groups is less than X. In other words, when the quantity of first transmit port groups is less than X, the quantity of first OCSs is less than or equal to the total quantity NG of transmit ports in the first transmit port group; and when the quantity of first transmit port groups is equal to X, the quantity of first OCSs is less than NG. Alternatively, when the quantity of first OCSs is less than NG, the quantity of first transmit port groups is less than or equal to X; and when the quantity of first OCSs is equal to NG, the quantity of first transmit port groups is less than X. In this way, when the configuration information includes a configuration of all transmit port groups, the configuration information does not include a configuration of all OCSs, and when the configuration information includes the configuration of all the OCSs, the configuration information does not include the configuration of all the transmit port groups. In other words, the quantity of first OCSs and the quantity of first transmit port groups are not simultaneously equal to a maximum value, and the configuration information may include a configuration of some transmit port groups and/or a configuration of some OCSs, to reduce indication overheads.

The configuration of the first transmit port group may indicate which first transmit port group is used when the reference signal is sent. For example, a total quantity N of transmit ports of the terminal device is 32, and there are a total of four transmit port groups: a transmit port group A, a transmit port group B, a transmit port group C, and a transmit port group D. 2 bits may indicate which first transmit port group is used when the reference signal is sent. For example, when the configuration information includes 00, it indicates that the transmit port group A may be used to send the reference signal; when the configuration information includes 01, it indicates that the transmit port group B may be used to send the reference signal; when the configuration information includes 10, it indicates that the transmit port group C may be used to send the reference signal; and when the configuration information includes 11, it indicates that the transmit port group D may be used to send the reference signal.

The configuration of the first OCS may indicate which sequence of the OCS is used when the reference signal is sent. An example in which a total quantity N of transmit ports of the terminal device is 32 is used below. If each transmit port group includes a same quantity of transmit ports, and there are eight transmit port groups, each transmit port group includes four transmit ports. A used OCS may be a 4*4 orthogonal matrix, and 2 bits may indicate an orthogonal code that is used by each transmit port in each transmit port group and that is in an OCS. For example, 00 indicates a first column (row) in the OCS, and 01 indicates a second column (row) in the OCS, 10 indicates a third column (row) in the OCS, and 11 indicates a fourth column (row) in the OCS.

For another example, a total quantity N of transmit ports of the terminal device is 32, quantities of transmit ports in transmit port groups are different, and a size of an OCS used by each transmit port group is equal to a quantity of transmit ports in the transmit port group. For example, a transmit port group A includes four transmit ports, an OCS corresponding to the transmit port group A is a 4*4 orthogonal matrix, and an indication may be 2-bit information corresponding to 00. A transmit port group B includes eight transmit ports, an OCS corresponding to the transmit port group B is an 8*8 orthogonal matrix, and an indication may be 3-bit information corresponding to 001 or the like. A transmit port group C includes 16 transmit ports, an OCS corresponding to the transmit port group C is a 16*16 orthogonal matrix, and an indication is 4-bit information corresponding to 0002 or the like. A transmit port group D includes four transmit ports, an OCS corresponding to the transmit port group D is a 4*4 orthogonal matrix, and an indication may be 2-bit information corresponding to 11.

It should be understood that the foregoing descriptions are all examples, and an indication type or a configuration type in the configuration information is not limited in this application. For example, the configuration information includes a plurality of lists A, and each list A includes identifiers of a plurality of combinations of transmit port groups and OCSs of the reference signal. Alternatively, the configuration information includes a plurality of lists B, each list B represents a plurality of transmit port groups of the reference signal, and the list B includes identifiers of different transmit port groups, which correspond to different transmit port groups. Alternatively, the configuration information includes a plurality of lists C, and each list C includes a sequence identifier of an OCS used by each of a plurality of transmit port groups of the reference signal. Alternatively, the configuration information includes indication information A, and the indication information indicates a mapping relationship between the first transmit port group and the first OCS used by the first transmit port group, and the like.

In some feasible examples, the communication method further includes: The network device sends first indication information to the terminal device. Correspondingly, the terminal device receives the first indication information from the network device.

The first indication information indicates division of transmit port groups and/or an OCS. For division of the transmit port groups, refer to the descriptions in operation S204. Details are not described herein again. The first indication information may include at least one of the indication information A, the list A, the list B, and the list C or partial content of one of the list A, the list B, and the list C, or may include: partial content of the plurality of lists, partial content of one list and the indication information A, partial content of the plurality of lists and the indication information A, or the like. This is not limited in this application. The first indication information may alternatively include an identifier of the list, may include an identifier of a transmit port and/or an identifier of an OCS, may include a type of a transmit port in a transmit port group, or may include an orthogonal code type (for example, a Hadamard or a DFT code, or a value corresponding to a port) of an OCS, or the like. The first indication information may be sent together with the configuration information, or may be separately sent.

It may be understood that, after the first indication information is received, N transmit ports may be divided to obtain X transmit port groups, and an OCS used by each transmit port group may be further obtained. The first indication information is used, so that efficiency of obtaining the transmit port group and the OCS can be improved, and efficiency of sending the reference signal through the transmit port group using the OCS can be improved.

In some feasible examples, the configuration information may further include a configuration of a frequency domain position of the reference signal. In this way, the reference signal may be sent at the frequency domain position of the reference signal.

The configuration of the frequency domain position of the reference signal may include information about the frequency domain position of the reference signal, and may be particular to all ports of the terminal device, or may be particular to a port. For example, a frequency domain position range belongs to R1 frequency domain units in P frequency domain units, where R1 is a quantity of orthogonal frequency domain units, and R1 is less than or equal to P. A combination identifier of the R1 frequency domain units may be P1, and P1 may indicate a location of a port for sending a reference signal in frequency domain, and the like. In an embodiment, indications of frequency domain positions of all transmit ports are the same. In an embodiment, frequency domain units used by all the transmit ports are the same. For example, REs, RBs, RBGs, and the like used by all the transmit ports are the same.

In some feasible examples, the configuration information is carried in control signaling, and the control signaling includes first sub-signaling and/or second sub-signaling. The first sub-signaling indicates the configuration of the first transmit port group, and the second sub-signaling indicates the configuration of the first OCS. If the configuration information may further indicate the configuration of the frequency domain position of the reference signal, the control signaling may further include third sub-signaling, and the third sub-signaling indicates the configuration of the frequency domain position of the reference signal.

The control signaling may be radio resource control (RRC) signaling, downlink control information (DCI), a media access control (MAC) layer control element (CE), or the like. This is not limited herein.

A signaling size of the first sub-signaling is L1 and satisfies

$$L 1 = ⌊ {log}_{2}^{N / N G} ⌋ ,$$

a signaling size of the second sub-signaling is L2 and satisfies

$$L 2 = ⌊ {log}_{2}^{NG} ⌋ ,$$

and a signaling size of the third sub-signaling is L3 and satisfies

$$L 3 = ⌊ {log}_{2}^{P} ⌋ .$$

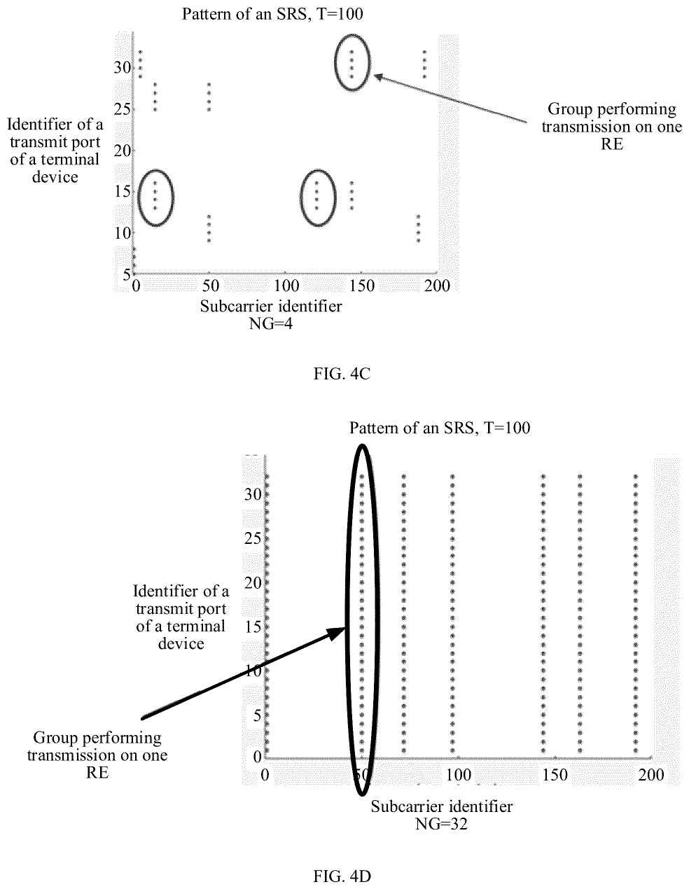

Content of the control signaling is not limited in this application. For a form of the control signaling, separately refer to FIG. 7A to FIG. 7C. For example, as shown in FIG. 7A, the control signaling includes the first sub-signaling, the second sub-signaling, and the third sub-signaling, so that the first transmit port group that can be used to send the reference signal, the first OCS used by the first transmit port group, and the frequency domain position of the reference signal may be determined. As shown in FIG. 7B, the control signaling includes the first sub-signaling and the third sub-signaling, so that the first transmit port group that can be used to send the reference signal and the frequency domain position of the reference signal may be determined. As shown in FIG. 7C, the control signaling includes the second sub-signaling and the third sub-signaling, so that the first OCS that can be used to send the reference signal and the configuration of the frequency domain position of the reference signal may be determined.

In an embodiment, X=N/NG. When NG is equal to N, and X is equal to 1, the control signaling includes the second sub-signaling; or when NG is equal to 1, and X is greater than 1 and equal to N, the control signaling includes the first sub-signaling.

It may be understood that, when X=N/NG, it indicates that quantities of transmit ports in all the transmit port groups are equal. When NG is equal to N, it indicates that all the N transmit ports are grouped into one transmit port group. The network device has known that the transmit ports in the transmit port group are all the transmit ports of the terminal device. In this case, the control signaling may not include the first sub-signaling, but include the second sub-signaling. When NG is equal to 1, and X is greater than 1 and equal to N, it indicates that each transmit port is grouped into one transmit port group. This may be understood as a solution in which a reference signal is sent through a single transmit port instead of a solution in which a reference signal is sent through a transmit port group. An OCS used by the transmit port group does not need to be determined. In this case, the control signaling may not include the second sub-signaling, but include the first sub-signaling. In the two cases, the control signaling may include the third sub-signaling.

A method for determining the configuration information by the network device is not limited in this application. In some feasible examples, the network device may further perform the following operations: aggregating the X transmit port groups based on NG OCSs to obtain a first vector; concatenating, based on channel information of T time domain units, vectors that correspond to the first vector and that are in the T time domain units, to obtain a first matrix; processing the first matrix to obtain a pattern of the reference signal; and determining the configuration information based on the pattern of the reference signal.

For division of the X transmit port groups, refer to the foregoing descriptions, for example, the descriptions in operation S204. This is not limited in this application. In some feasible examples, the network device may further perform the following operations: processing a fifth matrix to obtain a sixth matrix; constructing a second vector based on the N transmit ports, M receive ports, and R1 frequency domain units that are selected by using the sixth matrix; and splitting the N transmit ports based on the second vector to obtain the X transmit port groups.

The fifth matrix is a matrix including the N transmit ports, the M receive ports, and P frequency domain units, and may be understood as the matrix or tensor H described in operation S201. A quantity of rows of the sixth matrix is P, and a quantity of columns of the sixth matrix is R1. A location of a row in which an element whose value is 1 in the sixth matrix is located is used to determine the frequency domain position of the reference signal. The sixth matrix may be understood as the foregoing matrix C1. A method for processing the fifth matrix to obtain the sixth matrix is not limited. For example, the fifth matrix is decomposed to obtain an intermediate matrix; the intermediate matrix is compressed, to obtain the sixth matrix; and the like. For details, refer to the descriptions in operation S201 to operation S203. Details are not described herein again.

The second vector is a vector of the N transmit ports, the M receive ports, and the R1 frequency domain units that are selected based on the sixth matrix, and may be understood as a one-dimensional matrix obtained by converting a three-dimensional matrix including the R1 frequency domain units, the N transmit ports, and the M receive ports, for example, the foregoing vector H2. For a method for splitting the N transmit ports based on the second vector, refer to the descriptions in operation S204. Details are not described herein again.

It may be understood that the fifth matrix including the N transmit ports, the M receive ports, and the P frequency domain units is processed to obtain the sixth matrix used to identify the frequency domain position of the reference signal, and the R1 frequency domain units are selected from the P frequency domain units, so that matrix compression can be implemented, a matrix size can be reduced, and operation complexity can be reduced. Then, the second vector is constructed based on the N transmit ports, the M receive ports, and the R1 frequency domain units, and the N transmit ports are split based on the second vector to obtain the X transmit port groups, so that orthogonal coding is performed in a form of a transmit port group, thereby improving a transmit power and an SNR of communication transmission.

In this embodiment of this application, a quantity of elements of the first vector is NMR1, and the first vector may be understood as H3. A quantity of columns of the first matrix is NMR1, a quantity of rows of the first matrix is T, and the first matrix may be understood as the foregoing matrix CDM_multi. A method for processing the first matrix is not limited in this application. In some feasible examples, processing the first matrix to obtain the pattern of the reference signal may include the following operations: determining a second matrix in the first matrix; compressing the second matrix to obtain a third matrix and a fourth matrix; and determining the pattern of the reference signal based on the fourth matrix.

A quantity of columns of the second matrix is NMR1, a quantity of rows of the second matrix is R2, and R2 is a quantity of orthogonal subsets in a set including the X transmit port groups and the NG OCSs. A quantity of rows of the third matrix, a quantity of columns of the third matrix, and a quantity of columns of the fourth matrix are R2, a quantity of rows of the fourth matrix is NMR1, a location of a row in which an element whose value is 1 in the fourth matrix is located is used to determine a frequency domain position of the reference signal, and the fourth matrix may be understood as the foregoing matrix C2. For the processing method, refer to the descriptions in operation S206. Details are not described herein again. The first matrix is processed, so that the pattern of the reference signal is obtained through matrix decomposition and compression using a subspace projection algorithm, and overheads of the reference signal can be reduced. In addition, powers of a plurality of ports are aggregated, so that a transmit power and an SNR of communication transmission can be improved.

S602: The terminal device sends the reference signal to the network device based on the configuration information. Correspondingly, the network device receives the reference signal based on the configuration information.

A method for sending the reference signal based on the configuration information is not limited in this application. The following describes four cases corresponding to the configuration information.

Case 1: The configuration information includes the configuration of the first transmit port group and the configuration of the first OCS.

Case 2: The configuration information includes the configuration of the first OCS, and NG is equal to N.

Case 3: The configuration information includes the configuration of the first transmit port group.

Case 4: The configuration information includes the configuration of the first OCS, and NG is less than N.

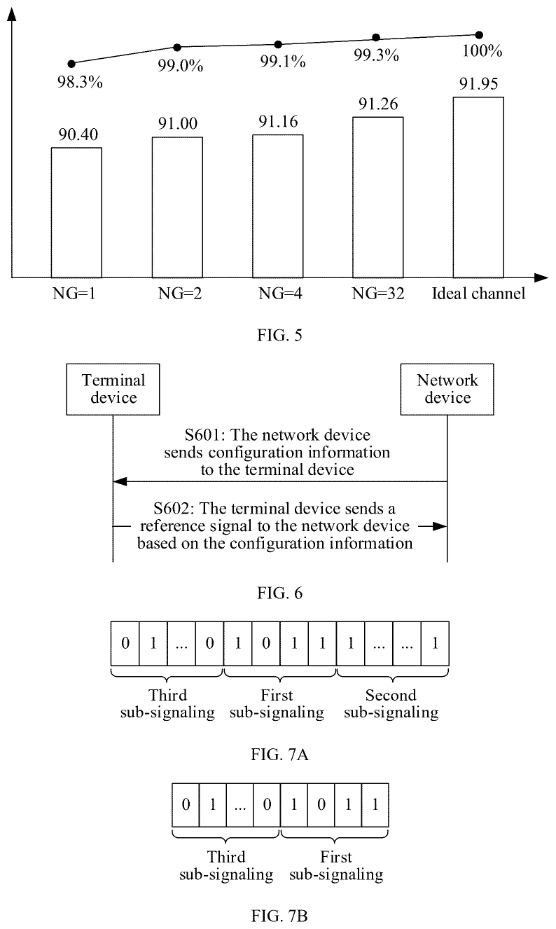

In Case 1, the reference signal is sent through the first transmit port group using the first OCS. For example, FIG. 8A to FIG. 8D each are a diagram in which a terminal device sends a reference signal through a first transmit port group using a first OCS. FIG. 8A to FIG. 8D respectively correspond to Case 1 to Case 4. As shown in FIG. 8A, assuming that N=32, quantities of transmit ports in all transmit port groups are equal, and NG=2, transmit ports of the terminal device are divided into 16 transmit port groups. The configuration information indicates an identifier of the first transmit port group and an identifier of the first OCS used by the first transmit port group. In FIG. 8A, an example in which two transmit port groups are used as two indicated first transmit port groups is used. An identifier of one first transmit port group is 0, sequence numbers of two transmit ports in the first transmit port group 0 are 1 and 2, and an identifier of a first OCS used by the first transmit port group 0 is 0000. An identifier of the other first transmit port group is 1, sequence numbers of two transmit ports in the first transmit port group 1 are 3 and 4, and an identifier of a first OCS used by the first transmit port group 1 is 0001. “+” symbols indicated on the transmit port whose sequence number is 1 and the transmit port whose sequence number is 2 indicate that a vector of the first OCS used by the first transmit port group 0 is {1, 1}. A “+” symbol indicated on the transmit port whose sequence number is 3 and a “−” symbol indicated on the transmit port whose sequence number is 4 indicate that a vector of the first OCS used by the first transmit port group 1 is {1, −1}.

It may be understood that, in Case 1, a configuration of some transmit port groups and a configuration of some OCSs are indicated, to reduce indication overheads. In addition, some transmit port groups and some OCSs used by the transmit port groups are indicated, so that transmit port groups of the terminal device and OCSs do not need to be all used. The terminal device may send the reference signal through some transmit port groups using some OCSs, so that overheads of the reference signal are reduced, a transmit power and an SNR of communication transmission can be improved, a measurement delay can be reduced, and channel estimation accuracy can be improved.

In Case 2, the reference signal is sent through N transmit ports using the first OCS. As shown in FIG. 8B, assuming that N=32 and NG=32, the terminal device includes one transmit port group, that is, X=1. A first transmit port group includes 32 transmit ports, and sequence numbers may be 1 to 32. The configuration information indicates an identifier of the first OCS, but does not indicate an identifier of the first transmit port group. The first transmit port group may use 32 OCSs. In FIG. 8B, an example in which two OCSs are used as two indicated first OCSs is used. An identifier of one first OCS is 00000, and an identifier of the other first OCS is 11111. It can be learned, based on a symbol indicated on each of the 32 transmit ports corresponding to the first OCS whose identifier is 00000, that values of elements in a vector of the first OCS are all 1. It can be learned, based on a symbol indicated on each of the 32 transmit ports corresponding to the first OCS whose identifier is 11111, that a value of an element in a vector of the first OCS is 1 or −1. For example, values of elements in the vector of the first OCS used by transmit ports whose sequence numbers are 1, 4, 31, and the like are 1, and values of elements in the vector of the first OCS used by transmit ports whose sequence numbers are 2, 3, 32, and the like are −1.

It may be understood that Case 2 is applicable to a scenario in which all transmit ports are grouped into one transmit port group, and the configuration of the first transmit port group is not indicated, to reduce indication overheads. Because NG=N, the terminal device includes one transmit port group, that is, X=1, the first transmit port group includes all the transmit ports (namely, the N transmit ports), and a quantity of first transmit port groups is equal to X. In this case, the quantity of first OCSs is less than NG, and the terminal device may send the reference signal on all the transmit port groups (all the transmit ports) by using some OCSs, to reduce overheads of the reference signal, improve a transmit power and an SNR of communication transmission, reduce a measurement delay, and improve channel estimation accuracy.

In Case 3, the reference signal is sent through the first transmit port group using NG OCSs. As shown in FIG. 8C, assuming that N=32, quantities of transmit ports in all transmit port groups are equal, and NG=2, transmit ports of the terminal device are divided into 16 transmit port groups. The configuration information indicates an identifier of the first transmit port group, but does not indicate an identifier of the first OCS used by the first transmit port group, and all OCSs need to be used. Because NG=2, a quantity of all the OCSs that can be used by the first transmit port group is 2. In FIG. 8C, an example in which two transmit port groups are used as two indicated first transmit port groups is used. An identifier of one first transmit port group is 0, and sequence numbers of two transmit ports in the first transmit port group 0 are 1 and 2. An identifier of the other first transmit port group is 1, and sequence numbers of two transmit ports in the first transmit port group 1 are 3 and 4. It can be learned, based on symbols indicated on the transmit ports whose sequence numbers are 1, 2, 3, and 4, that a vector of one of two OCSs that may be used by the two first transmit port groups is {1, 1}, and a vector of the other OCS is {1, −1}.

Still refer to FIG. 8C, each large circle corresponds to two OCSs that may be used by one first transmit port group, so that the terminal device sends the reference signal to the network device through the first transmit port group using all OCSs (the two OCSs). Symbols indicated on sequence numbers of transmit ports in the first transmit port group in a small circle represent a vector of a first OCS corresponding to the first transmit port group. After receiving the reference signal, the network device may identify the first OCS corresponding to the first transmit port group used for the reference signal.

It may be understood that, in the scenario of Case 3, the first OCS used by the first transmit port group is not indicated. This further reduces indication overheads in comparison with the scenario of indicating the first transmit port group and the first OCS. Because an OCS used to send the reference signal is not indicated, the terminal device does not know the OCS used to send the reference signal, and needs to use all OCSs, namely, the NG OCSs. When the quantity of first OCSs is equal to NG, the quantity of first transmit port groups is less than X. Therefore, some transmit port groups using all OCSs may be used to send the reference signal, to reduce overheads of the reference signal, improve a transmit power and an SNR of communication transmission, reduce a measurement delay, and improve channel estimation accuracy.

In Case 4, the reference signal is sent through X transmit port groups using the first OCS. As shown in FIG. 8D, assuming that N=32, quantities of transmit ports in all transmit port groups are equal, and NG=16, transmit ports of the terminal device are divided into 2 transmit port groups. The configuration information indicates an identifier of the OCS, but does not indicate an identifier of the first transmit port group. Therefore, all transmit port groups, namely, two transmit port groups, need to be used. Sequence numbers of transmit ports in one transmit port group are 1 to 16, and sequence numbers of transmit ports in the other transmit port group are 17 to 32. A quantity of OCSs that may be used by the two transmit port groups is 16. In FIG. 8D, an example in which two OCSs are used as two indicated first OCSs is used. An identifier of one first OCS is 0000, and an identifier of the other first OCS is 0001. In addition, it can be learned, based on symbols indicated on transmit ports corresponding to sequence numbers 1 to 16 and symbols indicated on transmit ports corresponding to sequence numbers 17 to 32, that values of elements in a vector are all 1 when the transmit port group corresponding to the sequence numbers 1 to 16 and the transmit port group corresponding to the sequence numbers 17 to 32 each use the first OCS whose identifier is 0000, and values of elements in a vector are 1 or −1 when the two transmit port groups each use the first OCS whose identifier is 0001. For example, an element in a vector is 1 when a transmit port whose sequence number is 1 in one transmit port group uses the first OCS whose identifier is 0001, and an element in the vector is −1 when a transmit port whose sequence number is 2 or 16 in the transmit port group uses the first OCS whose identifier is 0001; and an element in a vector is 1 when a transmit port whose sequence number is 17 in the other transmit port group uses the first OCS whose identifier is 0001, and an element in the vector is −1 when a transmit port whose sequence number is 18 or 32 in the transmit port group uses the first OCS whose identifier is 0001.

Still refer to FIG. 8D, each large circle corresponds to one OCS that may be used by two transmit port groups, a value indicated on a sequence number of a transmit port in each transmit port group indicates a value of the OCS used when the terminal device sends the reference signal through the transmit port group, and values in a transmit port group in a small circle in the large circle are values of an OCS provided by the network device for the terminal device to use. In this way, the terminal device may send the reference signal through all transmit ports (namely, the 32 transmit ports) using some indicated OCSs.

It may be understood that, the configuration information in Case 4 does not indicate a configuration of the transmit port group. This further reduces indication overheads in comparison with the scenario of indicating the first transmit port group and the first OCS. Because NG is less than N, the first transmit port group does not include all the transmit ports, and X is greater than 1. In addition, because the first transmit port group used to send the reference signal is not indicated, the terminal device does not know the transmit port group used to send the reference signal, and needs to use all the transmit port groups, that is, the X transmit port groups. In other words, the quantity of first transmit port groups is equal to X. In this case, the quantity of first OCSs is less than NG. Therefore, all the transmit port groups using some OCSs may be used to send the reference signal, to reduce overheads of the reference signal, improve a transmit power and an SNR of communication transmission, reduce a measurement delay, and improve channel estimation accuracy.

It should be noted that the configuration information corresponding to the foregoing four cases is merely used as an example. Actually, another case of the configuration information may be further included for sending the reference signal.

In the method shown in FIG. 6, after receiving the configuration information, the terminal device may send the reference signal based on the configuration information. The configuration information indicates to send the reference signal through the first transmit port group using the first OCS, and the configuration information includes the configuration of the first transmit port group and/or the configuration of the first OCS. The quantity of first transmit port groups is less than or equal to the total quantity X of transmit port groups of the terminal device, and the quantity of first OCSs is less than or equal to the total quantity NG of transmit ports in the first transmit port group. When the quantity of first transmit port groups is equal to X, the quantity of first OCSs is less than NG; and when the quantity of first OCSs is equal to NG, the quantity of first transmit port groups is less than X. In this way, when the configuration information includes a configuration of all transmit port groups, the configuration information does not include a configuration of all OCSs, and when the configuration information includes the configuration of all the OCSs, the configuration information does not include the configuration of all the transmit port groups. In other words, the quantity of first OCSs and the quantity of first transmit port groups are not simultaneously equal to a maximum value, and the configuration information indicates a configuration of some transmit port groups and/or a configuration of some OCSs, to reduce indication overheads. After receiving the configuration information, the terminal device may send the reference signal through some transmit port groups using an OCS or through a transmit port group using some OCSs, and does not need to send the reference signal through all transmit port groups using all OCSs. This reduces overheads of the reference signal, can improve a transmit power and an SNR of communication transmission, can reduce a measurement delay, and can improve channel estimation accuracy.

In some feasible examples, the method may further include: The network device restores a first channel based on the reference signal. In this way, a channel between the terminal device and the network device is restored by using the reference signal used for channel estimation, so that restoration accuracy can be improved.

A method for restoring the first channel is not limited in this application, and restoration may be performed based on the foregoing four cases of the configuration information.

In Case 1 and Case 2, the network device obtains a second channel based on the reference signal, and restores the first channel based on the second channel.

In Case 3, the network device obtains a third channel based on the reference signal, selects a second channel from the third channel, and restores the first channel based on the second channel.

In Case 4, the network device obtains a fourth channel based on the reference signal, selects a second channel from the fourth channel, and restores the first channel based on the second channel.

In this embodiment of this application, the second channel, the third channel, and the fourth channel each may be understood as a channel corresponding to a transmit port group that uses an OCS and that is actually used to send the reference signal. Because the configuration information in Case 1 indicates the configuration of the first transmit port group and the configuration of the first OCS, the configuration information in Case 2 indicates the configuration of the first transmit port group, and the first transmit port group in Case 2 includes all the transmit ports, the reference signal may be understood as being sent through the first transmit port group using the first OCS, and the second channel for transmitting the reference signal may be restored based on the received reference signal.

Because the configuration of the first OCS is not indicated in Case 3, all the OCSs (namely, the NG OCSs) are used to send the reference signal. The third channel for transmitting the reference signal needs to be restored based on the received reference signal, and then actually used OCSs and transmit port groups are selected from the third channel, to obtain the second channel. Because the configuration of the first transmit port group is not indicated in Case 4, all the transmit port groups (namely, the X transmit port groups) are used to send the reference signal. The fourth channel for sending the reference signal needs to be restored based on the received reference signal, and then actually used OCSs and transmit port groups are selected from the fourth channel, to obtain the second channel. After the second channel is restored, OCS decoding needs to be performed on the second channel, to restore the first channel between the terminal device and the network device. It may be understood that the first channel is separately restored based on the foregoing four cases, so that accuracy of channel restoration can be improved, thereby helping improve accuracy of channel estimation.

Further, in some feasible examples, the method may further include: The network device restores the first channel based on the second channel, the second matrix, and the fourth matrix. For example, an observation matrix is determined based on the second channel and the reference signal, a to-be-decoded matrix is constructed based on the observation matrix, the second matrix, and the fourth matrix, and OCS decoding is performed on the to-be-decoded matrix to obtain the first channel. For the method, refer to the descriptions in operation S207 and operation S208. Details are not described herein again. It may be understood that, the second channel is restored based on the second matrix and the fourth matrix, so that accuracy of channel restoration can be further improved, thereby helping improve accuracy of channel estimation.

The method in embodiments of this application is described in detail above. The following provides an apparatus in embodiments of this application. The apparatus has a corresponding function of implementing the method. The function may be implemented by hardware, or may be implemented by hardware executing corresponding software. The hardware or the software includes one or more modules or units or means corresponding to the function. The following uses a unit as an example.

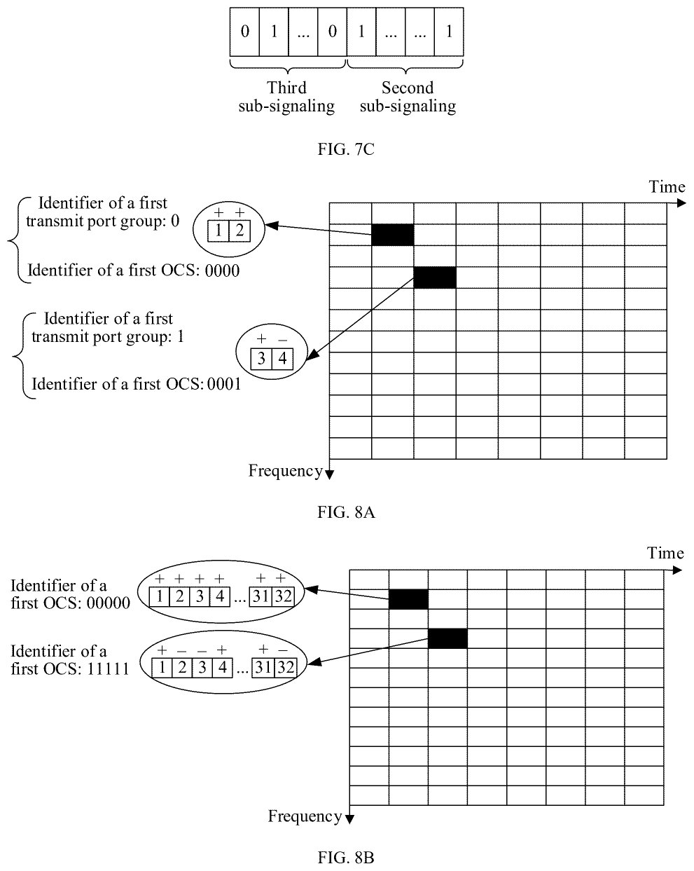

FIG. 9 is a diagram of a structure of a communication apparatus according to an embodiment of this application. The communication apparatus may include a receiving unit 901, a sending unit 902, and a processing unit 903. The receiving unit 901 may be an apparatus having signal input (receiving). The sending unit 902 may be an apparatus having signal output (sending) apparatus. The receiving unit 901 and/or the sending unit 902 are/is configured to transmit a signal to another device or another component in the device.

The processing unit 903 may be an apparatus having a processing function, and may include one or more processors. The processor may be a general-purpose processor, a dedicated processor, or the like. The processor may be a baseband processor or a central processing unit. The baseband processor may be configured to process a communication protocol and communication data. The central processing unit may be configured to: control the apparatus (for example, a donor node, a relay node, or a chip), execute a software program, and process data of the software program.

The communication apparatus may include a terminal device and a network device. In this embodiment, a function performed by the terminal device may be performed by an apparatus in the terminal device, or may be an apparatus that can be used in combination with the terminal device. The network device in this embodiment may be the network device in the communication system. In this embodiment, a function performed by the network device may be performed by an apparatus in the network device, or may be an apparatus that can be used in combination with the network device. The following uses the terminal device or the network device as an example.

When the communication apparatus is the terminal device, the communication apparatus includes: the receiving unit 901, configured to receive configuration information; and the sending unit 902, configured to send a reference signal based on the configuration information. The configuration information indicates to send the reference signal through a first transmit port group using a first OCS, the configuration information includes a configuration of the first transmit port group and/or a configuration of the first OCS, a quantity of first transmit port groups is less than or equal to a total quantity X of transmit port groups of the terminal device, a quantity of first OCSs is less than or equal to a total quantity NG of transmit ports in the first transmit port group, when the quantity of first transmit port groups is equal to X, the quantity of first OCSs is less than NG, and when the quantity of first OCSs is equal to NG, the quantity of first transmit port groups is less than X.

In some feasible examples, the configuration information is carried in control signaling, the control signaling includes first sub-signaling and/or second sub-signaling, the first sub-signaling indicates the configuration of the first transmit port group, the second sub-information indicates the configuration of the first OCS, a signaling size of the first sub-signaling is L1 and satisfies

$$L 1 = ⌊ {log}_{2}^{N / N G} ⌋ ,$$

a signaling size of the second sub-signaling is L2 and satisfies

$$L 2 = ⌊ {log}_{2}^{NG} ⌋ ,$$

and N is a total quantity of transmit ports of the terminal device.

In some feasible examples, X=N/NG; and when NG is equal to N, and X is equal to 1, the control signaling includes the second sub-signaling; or when NG is equal to 1, and X is greater than 1 and equal to N, the control signaling includes the first sub-signaling.

In some feasible examples, when the configuration information includes the configuration of the first transmit port group and the configuration of the first OCS, the reference signal is sent through the first transmit port group using the first OCS. Alternatively, when the configuration information includes the configuration of the first OCS, and NG is equal to N, the reference signal is sent through the N transmit ports using the first OCS. Alternatively, when the configuration information includes the configuration of the first transmit port group, the reference signal is sent through the first transmit port group using NG first OCSs. Alternatively, when the configuration information includes the configuration of the first OCS, and NG is less than N, the reference signal is sent through the X transmit port groups using the first OCS.

In some feasible examples, the receiving unit 901 is further configured to receive first indication information, where the first indication information indicates division of the transmit port groups and/or the OCS.

In some feasible examples, the configuration information further includes a configuration of a frequency domain position of the reference signal.

When the communication apparatus is the network device, the communication apparatus includes: the sending unit 902, configured to send configuration information; and the receiving unit 901, configured to receive a reference signal based on the configuration information. The configuration information indicates to send the reference signal through a first transmit port group using a first OCS, the configuration information includes a configuration of the first transmit port group and/or a configuration of the first OCS, a quantity of first transmit port groups is less than or equal to a total quantity X of transmit port groups of the terminal device, a quantity of first OCSs is less than or equal to a total quantity NG of transmit ports in the first transmit port group, when the quantity of first transmit port groups is equal to X, the quantity of first OCSs is less than NG, and when the quantity of first OCSs is equal to NG, the quantity of first transmit port groups is less than X.

In some feasible examples, the configuration information is carried in control signaling, the control signaling includes first sub-signaling and/or second sub-signaling, the first sub-signaling indicates the configuration of the first transmit port group, the second sub-information indicates the configuration of the first OCS, a signaling size of the first sub-signaling is L1 and satisfies

$$L 1 = ⌊ {log}_{2}^{N / N G} ⌋ ,$$

a signaling size of the second sub-signaling is L2 and satisfies

$$L 2 = ⌊ {log}_{2}^{NG} ⌋ ,$$

and N is a total quantity of transmit ports of the terminal device.

In some feasible examples, X=N/NG; and when NG is equal to N, and X is equal to 1, the control signaling includes the second sub-signaling; or when NG is equal to 1, and X is greater than 1 and equal to N, the control signaling includes the first sub-signaling.

In some feasible examples, the processing unit 903 is configured to restore a first channel based on the reference signal.

In some feasible examples, when the configuration information includes the configuration of the first transmit port group and the configuration of the first OCS, the processing unit 903 is configured to: obtain a second channel based on the reference signal; and restore the first channel based on the second channel.

Alternatively, in some feasible examples, when the configuration information includes the configuration of the first OCS, and NG is equal to N, the processing unit is configured to: obtain a second channel based on the reference signal; and restore the first channel based on the second channel.

Alternatively, in some feasible examples, when the configuration information includes the configuration of the first transmit port group, the processing unit is configured to: obtain a third channel based on the reference signal, and select a second channel from the third channel; and restore the first channel based on the second channel.

Alternatively, in some feasible examples, when the configuration information includes the configuration of the first OCS, and NG is less than N, the processing unit is configured to: obtain a fourth channel based on the reference signal, and select a second channel from the fourth channel; and restore the first channel based on the second channel.

In some feasible examples, the processing unit 903 is configured to: aggregate the X transmit port groups based on NG OCSs to obtain a first vector; concatenate, based on channel information of T time domain units, vectors that correspond to the first vector and that are in the T time domain units, to obtain a first matrix; process the first matrix to obtain a pattern of the reference signal; and determine the configuration information based on the pattern of the reference signal. A quantity of elements in the first vector is NMR1, M is a total quantity of receive ports of the communication apparatus, a quantity of columns of the first matrix is NMR1, a quantity of rows of the first matrix is T, and T is greater than 1.

In some feasible examples, the processing unit 903 is configured to: decompose the first matrix to obtain a second matrix; compress the second matrix to obtain a third matrix and a fourth matrix; and determine the pattern of the reference signal based on the fourth matrix, where a quantity of columns of the second matrix is NMR1, a quantity of rows of the second matrix is R2, R2 is a quantity of orthogonal subsets in a set including the X transmit port groups and the NG orthogonal code sequences, a quantity of rows of the third matrix, a quantity of columns of the third matrix, and a quantity of columns of the fourth matrix are R2, a quantity of rows of the fourth matrix is NMR1, and a location of a row in which an element whose value is 1 in the fourth matrix is located is used to determine a frequency domain position of the reference signal.

In some feasible examples, the processing unit 903 is further configured to: process a fifth matrix to obtain a sixth matrix; construct a second vector based on the N transmit ports, the M receive ports, and R1 frequency domain units that are selected by using the sixth matrix; and split the N transmit ports based on the second vector to obtain the X transmit port groups, where the fifth matrix is a matrix including the N transmit ports, the M receive ports, and P frequency domain units, a quantity of rows of the sixth matrix is P, a quantity of columns of the sixth matrix is R1, a location of a row in which an element whose value is 1 in the sixth matrix is located is used to determine a frequency domain position of the reference signal, a quantity of columns of the fifth matrix is R1, a quantity of rows of the fifth matrix is P, and P is a total quantity of frequency domain units.

In some feasible examples, the processing unit 903 is further configured to restore the first channel based on the second channel, the second matrix, and the fourth matrix.

In some feasible examples, the sending unit 902 is further configured to send first indication information, where the first indication information indicates division of the transmit port groups and/or the OCS.

In some feasible examples, the configuration information further includes a configuration of the frequency domain position of the reference signal.

For embodiments of the receiving unit 901, the sending unit 902, and the processing unit 903, refer to the related descriptions in the method embodiment shown in FIG. 6. Details are not described herein again.

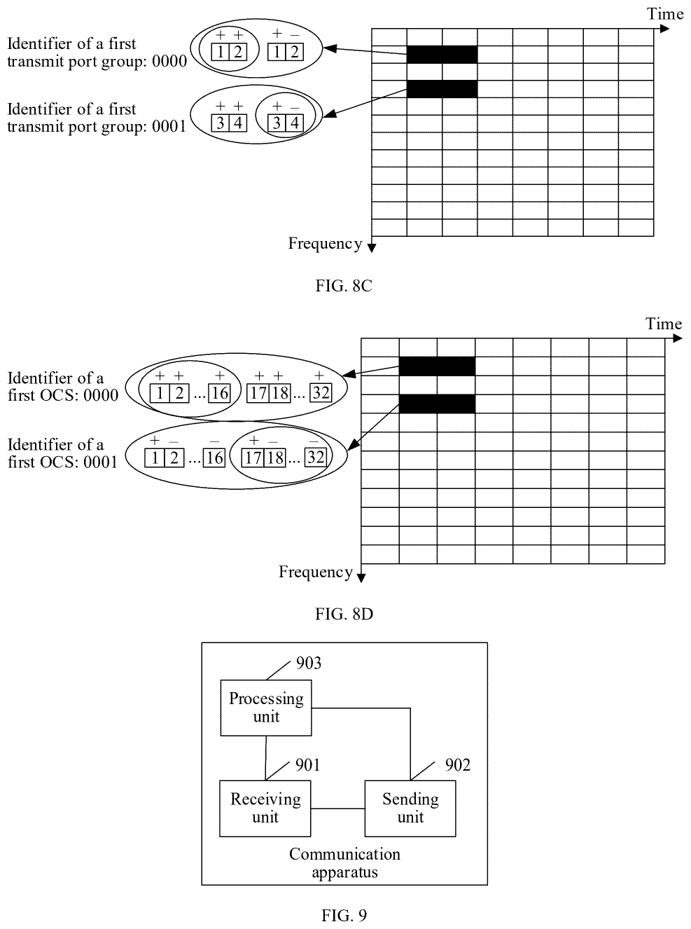

FIG. 10 is a diagram of a structure of another communication apparatus according to an embodiment of this application. It may be understood that the communication apparatus includes forms such as a module, a unit, an element, a circuit, or an interface, to be appropriately configured together to perform the solutions. The communication apparatus may be a RAN node, a terminal, a core network device, or another network device, or may be a component (for example, a chip) in these devices, and is configured to implement the method described in the method embodiment.

As shown in FIG. 10, the communication apparatus may include one or more processors 111. The processor 111 may also be referred to as a processing unit, and can implement a control function. The processor 111 may be a general-purpose processor, a dedicated processor, or the like. For example, the processor may be a baseband processor or a central processing unit. The baseband processor may be configured to process a communication protocol and communication data. The central processing unit may be configured to: control the communication apparatus (for example, a base station, a baseband chip, a terminal, a terminal chip, a DU, or a CU), execute a software program, and process data of the software program.

In an embodiment, the processor 111 may include a program 113 (which may also be referred to as code or instructions sometimes). The program 113 may be run on the processor 111, to enable the communication apparatus to perform the method described in the method embodiment.

In another embodiment, the processor 111 may include a transceiver unit configured to implement receiving and sending functions. For example, the transceiver unit may be a transceiver circuit, an interface, an interface circuit, or a communication interface. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In still another possible design, the communication apparatus may include a circuit, and the circuit can implement the sending, receiving, or communication function in the foregoing method embodiment.

In an embodiment, the communication apparatus may include one or more memories 112 having a program 114 (which may also be referred to as code or instructions sometimes) stored thereon. The program 114 may be run on the processor 111, so that the communication apparatus performs the method described in the foregoing method embodiment.

In an embodiment, the processor 111 may include an AI module 117, and/or the memory 112 may include an AI module 118. The AI module is configured to implement an AI-related function. The AI module may be implemented by using software, hardware, or a combination of the software and the hardware. For example, the AI module may include an RIC module. For another example, the AI module may be a near-real-time RIC or a non-real-time RIC.

In an embodiment, the processor 111 and/or the memory 112 may further store data. The processor and the memory may be separately disposed, or may be integrated together. For example, the correspondence described in the foregoing method embodiment may be stored in the memory or stored in the processor.

In an embodiment, the communication apparatus may further include a transceiver 115 and/or an antenna 116. The processor 111 may also be sometimes referred to as a processing unit, and controls the communication apparatus (for example, the RAN node or the terminal). The transceiver 115 may also be referred to as a transceiver unit, a transceiver machine, a transceiver circuit, a transceiver, or the like, and is configured to implement receiving and sending functions of the communication apparatus via the antenna 116.

In an embodiment, the communication apparatus may be configured to perform any method described in FIG. 6 in embodiments of this application.

In an embodiment, the communication apparatus may be a terminal device, may be an apparatus in the terminal device, or may be an apparatus that can be used in combination with the terminal device. When the computer program instructions stored in the memory 112 are executed, the processor 111 is configured to perform an operation performed by the processing unit 903 in the foregoing embodiment. The transceiver 115 is configured to perform operations performed by the receiving unit 901 and/or the sending unit 902 in the foregoing embodiment. The transceiver 115 is further configured to send information to a communication apparatus other than the communication apparatus. The terminal device or the apparatus in the terminal device may be further configured to perform any method performed by the terminal device in the method embodiment in FIG. 6. Details are not described herein again.

In an embodiment, the communication apparatus may be a network device, an apparatus in the network device, or an apparatus that can be used in combination with the network device. When the computer program instructions stored in the memory 112 are executed, the processor 111 is configured to control the transceiver 115 to perform the operations performed by the receiving unit 901 and/or the sending unit 902 in the foregoing embodiment. The transceiver 115 is further configured to receive information from a communication apparatus other than the communication apparatus. The network device or the apparatus in the network device may be further configured to perform any method performed by the network device in the method embodiment in FIG. 6. Details are not described herein again.

The processor and the transceiver described in this application may be implemented on an integrated circuit (IC), an analog IC, a radio frequency integrated circuit (RFIC), a mixed-signal IC, an application specific integrated circuit (ASIC), a printed circuit board (printed circuit board, PCB), an electronic device, or the like. The processor and the transceiver may be manufactured by using various IC process technologies, for example, a complementary metal oxide semiconductor (CMOS), an N-type metal oxide semiconductor (nMetal-oxide-semiconductor, NMOS), a P-type metal oxide semiconductor (positive channel metal oxide semiconductor, PMOS), a bipolar junction transistor (BJT), a bipolar CMOS (BiCMOS), silicon germanium (SiGe), and gallium arsenide (GaAs).

The communication apparatus described in the foregoing embodiment may be the terminal device or the network device. However, a scope of the apparatus described in this application is not limited thereto, and the structure of the communication apparatus may not be limited by FIG. 10. The apparatus may be an independent device, or may be a part of a larger device. For example, the communication apparatus may be:
(1) an independent integrated circuit IC, a chip, a chip system, or a subsystem;
(2) a set including one or more ICs, where In an embodiment, the IC set may include a storage component configured to store data and/or instructions;
(3) an ASIC, for example, a modem (MSM);
(4) a module that can be embedded in another device; or
(5) the terminal device or the network device.

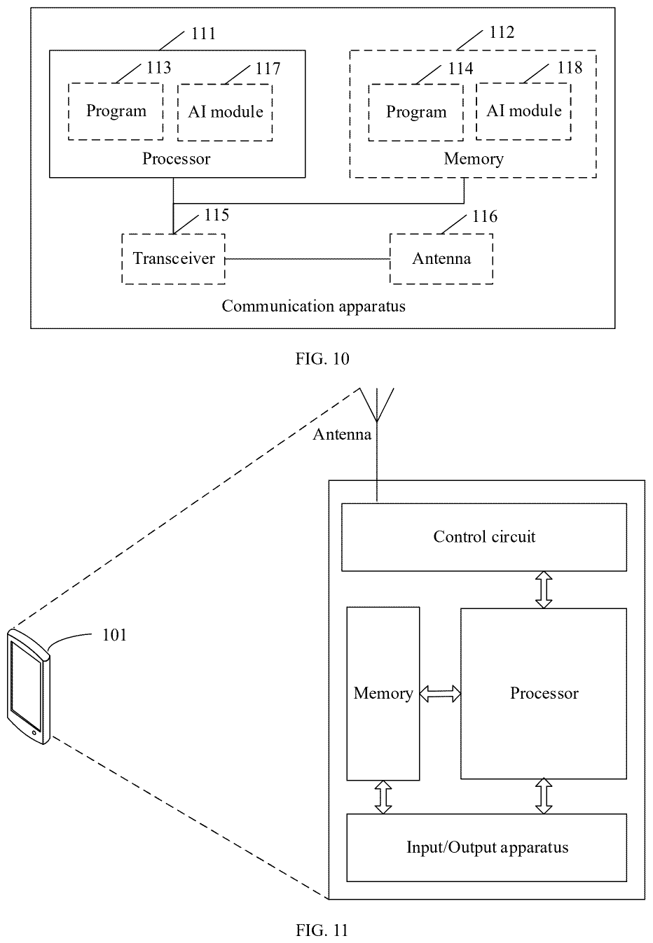

FIG. 11 is a diagram of a structure of a terminal device according to an embodiment of this application. For ease of description, FIG. 11 shows only main components of the terminal device. As shown in FIG. 11, the terminal device 101 includes a processor, a memory, a control circuit, an antenna, and an input/output apparatus. The processor is mainly configured to: process a communication protocol and communication data, control the entire terminal device, execute a software program, and process data of the software program. The memory is mainly configured to store the software program and the data. The radio frequency circuit is mainly configured to: perform conversion between a baseband signal and a radio frequency signal, and process the radio frequency signal. The antenna is mainly configured to receive and send a radio frequency signal in a form of an electromagnetic wave. The input/output apparatus, such as a touchscreen, a display, or a keyboard, is mainly configured to: receive data input by a user and output data to the user.

After the terminal device is powered on, the processor may read a software program in a storage unit, parse and execute instructions of the software program, and process data of the software program. When data needs to be sent in a wireless manner, the processor performs baseband processing on the to-be-sent data, and outputs a baseband signal to the radio frequency circuit. The radio frequency circuit processes the baseband signal to obtain a radio frequency signal, and sends the radio frequency signal to the outside in an electromagnetic wave form by using the antenna. When data is sent to the terminal device, the radio frequency circuit receives the radio frequency signal through the antenna. The radio frequency signal is further converted into a baseband signal, and the baseband signal is output to the processor. The processor converts the baseband signal into data, and processes the data.

For ease of description, FIG. 11 shows only one memory and one processor. In an actual terminal device, there may be a plurality of processors and memories. The memory may also be referred to as a storage medium, a storage device, or the like. This is not limited in embodiments of this application.

In an embodiment, the processor may include a baseband processor and a central processing unit. The baseband processor is mainly configured to process the communication protocol and the communication data. The central processing unit is mainly configured to control the entire terminal device, execute a software program, and process data of the software program. The processor in FIG. 11 integrates functions of the baseband processor and the central processing unit. A person skilled in the art may understand that the baseband processor and the central processing unit may be processors independent of each other, and are interconnected by using a technology, for example, a bus. A person skilled in the art may understand that the terminal device may include a plurality of baseband processors to adapt to different network standards, and the terminal device may include a plurality of central processing units to enhance processing capabilities of the terminal device, and components of the terminal device may be connected through various buses. The baseband processor may alternatively be expressed as a baseband processing circuit or a baseband processing chip. The central processing unit may alternatively be expressed as a central processing circuit or a central processing chip. A function of processing the communication protocol and the communication data may be built in the processor, or may be stored in the storage unit in a form of a software program, and the processor executes the software program to implement a baseband processing function.

In an example, the antenna and the control circuit having a transceiver function may be considered as a transceiver unit of the terminal device 101, and the processor having a processing function may be considered as a processing unit of the terminal device 101. The transceiver unit may also be referred to as a transceiver, a transceiver machine, a transceiver apparatus, or the like. In an embodiment, a component that is in the transceiver unit and that is configured to implement a receiving function may be considered as a receiving unit, and a component that is in the transceiver unit and that is configured to implement a sending function may be considered as a sending unit. In other words, the transceiver unit includes the receiving unit and the sending unit. For example, the receiving unit may also be referred to as a receiver, a receive machine, a receiving circuit, or the like, and the sending unit may also be referred to as a transmitter, a transmit machine, a transmitting circuit, or the like. In an embodiment, the receiving unit and the sending unit may be one integrated unit, or may be a plurality of independent units. The receiving unit and the sending unit may be in one geographical location, or may be distributed in a plurality of geographical locations.

In an embodiment, the transceiver unit is configured to perform operations performed by the receiving unit 901 and/or the sending unit 902 in the foregoing embodiment. The processing unit is configured to perform an operation performed by the processing unit 903 in the foregoing embodiment. The terminal device 101 may be further configured to perform any method performed by the terminal device in the method embodiment in FIG. 6. Details are not described herein again.

An embodiment of this application further provides a computer-readable storage medium. The computer-readable storage medium stores a computer program. When the program is executed by a processor, a procedure related to the terminal device or the network device in the communication method provided in the foregoing method embodiments may be implemented.

An embodiment of this application further provides a computer program product. When the computer program product runs on a computer or a processor, the computer or the processor is enabled to perform one or more operations in any one of the foregoing communication methods. When component modules of the foregoing device are implemented in a form of a software functional unit and sold or used as an independent product, the component modules may be stored in a computer-readable storage medium.

An embodiment of this application provides a chip, including a processor, configured to: invoke, from a memory, instructions stored in the memory, and run the instructions, to enable a communication apparatus in which the chip is installed to perform any one of the foregoing methods.

An embodiment of this application further provides another chip, including an input interface, an output interface, and a processing circuit. The input interface, the output interface, and the circuit are connected through an internal connection path, and the processing circuit is configured to perform any one of the foregoing methods. In an embodiment, the chip further includes a memory. The input interface, the output interface, a processor, and the memory are connected through an internal connection path. The processor is configured to execute code in the memory. When the code is executed, the processor is configured to perform any one of the foregoing methods.

An embodiment of this application further provides a chip system, including at least one processor and a communication interface. The communication interface and the at least one processor are interconnected through a line, and the at least one processor is configured to run a computer program or instructions, to perform any one of the foregoing methods. The chip system may include a chip, or may include a chip and another discrete component.

An embodiment of this application further provides a communication system. The system includes a terminal device and a network device. For descriptions, refer to any method shown in FIG. 6.

It should be understood that the memory mentioned in embodiments of this application may be a volatile memory or a non-volatile memory, or may include both a volatile memory and a non-volatile memory. The non-volatile memory may be a hard disk drive (HDD), a solid-state drive (SSD), a ROM, a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a RAM, and is used as an external cache. The memory is any other medium that can carry or store expected program code in a form of an instruction or a data structure and that can be accessed by a computer, but is not limited thereto. The memory in embodiments of this application may alternatively be a circuit or any other apparatus that can implement a storage function, and is configured to store the program instructions and/or the data.

It should be further understood that the processor in embodiments of this application may be a central processing unit (CPU), or may be another general-purpose processor, a digital signal processor (DSP), an application specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be noted that when the processor is a general-purpose processor, a DSP, an ASIC, an FPGA, or another programmable logic device, a discrete gate, a transistor logic device, or a discrete hardware component, the memory (a storage module) is integrated into the processor.

It should be noted that the memory described in this specification aims to include but is not limited to these memories and any memory of another proper type.

A person of ordinary skill in the art may be aware that units and algorithm operations in the examples described with reference to embodiments provided in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the embodiment goes beyond the scope of this application.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units may be integrated into one unit.

A sequence of the operations of the method in embodiments of this application may be adjusted, combined, or removed based on an actual requirement. Operations in each embodiment may be partially performed (for example, the terminal device may not perform the operations performed by the terminal device in the foregoing embodiments). An execution sequence of different operations can be changed. Embodiments described in this specification may be combined with other embodiments, different embodiments may be combined with each other, and different operations of different embodiments in this specification may be combined.

The modules/units in the apparatus in embodiments of this application may be combined, divided, and removed based on an actual requirement.

“Embodiments” mentioned herein mean that specific features, structures, or characteristics described in combination with embodiments may be included in at least one embodiment of this application. The phrase shown in various locations in this specification may not necessarily refer to a same embodiment, and is not an independent or discretionary embodiment exclusive from another embodiment.

In this application, the communication protocol may be a communication protocol or a specification, for example, a 3GPP communication protocol.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

What is claimed is:

1. A communication method, comprising:
receiving configuration information, wherein
the configuration information indicates to send a reference signal through a first transmit port group using a first orthogonal code sequence;
the configuration information comprises at least one of a configuration of the first transmit port group or a configuration of the first orthogonal code sequence;
a quantity of first transmit port groups is less than or equal to a total quantity X of transmit port groups of a terminal device;
a quantity of first orthogonal code sequences is less than or equal to a total quantity of transmit ports (NG) in the first transmit port group;
when the quantity of first transmit port groups is equal to X, the quantity of first orthogonal code sequences is less than NG; and
when the quantity of first orthogonal code sequences is equal to NG, the quantity of first transmit port groups is less than X; and
sending the reference signal based on the configuration information.

2. The method according to claim 1, wherein
the configuration information is carried in control signaling that comprises at least one of first sub-signaling or second sub-signaling;
the first sub-signaling indicates the configuration of the first transmit port group;
the second sub-signaling indicates the configuration of the first orthogonal code sequence;
a signaling size of the first sub-signaling is L1 and satisfies
$$L 1 = ⌊ {log}_{2}^{N / N G} ⌋ ;$$
a signaling size of the second sub-signaling is L2 and satisfies
$$L 2 = ⌊ {log}_{2}^{N G} ⌋ ;$$
and
N is a total quantity of transmit ports of the terminal device.

3. The method according to claim 2, wherein
X=N/NG; and
when NG is equal to N, and X is equal to 1, the control signaling comprises the second sub-signaling; or
when NG is equal to 1, and X is greater than 1 and equal to N, the control signaling comprises the first sub-signaling.

4. The method according to claim 1, wherein
when the configuration information comprises the configuration of the first transmit port group and the configuration of the first orthogonal code sequence, the reference signal is sent through the first transmit port group using the first orthogonal code sequence; or
when the configuration information comprises the configuration of the first orthogonal code sequence, and NG is equal to the total quantity N of transmit ports of the terminal device, the reference signal is sent through the N transmit ports using the first orthogonal code sequence; or
when the configuration information comprises the configuration of the first transmit port group, the reference signal is sent through the first transmit port group using NG orthogonal code sequences; or
when the configuration information comprises the configuration of the first orthogonal code sequence, and NG is less than the total quantity N of transmit ports of the terminal device, the reference signal is sent through X transmit port groups using the first orthogonal code sequence.

5. The method according to claim 1, further comprising:
receiving first indication information that indicates at least one of division of the transmit port groups or the orthogonal code sequence.

6. The method according to claim 1, wherein the configuration information further comprises a configuration of a frequency domain position of the reference signal.

7. A communication method, comprising:
sending configuration information, wherein
the configuration information indicates to send a reference signal through a first transmit port group using a first orthogonal code sequence;
the configuration information comprises at least one of a configuration of the first transmit port group or a configuration of the first orthogonal code sequence;
a quantity of first transmit port groups is less than or equal to a total quantity X of transmit port groups of a terminal device;
a quantity of first orthogonal code sequences is less than or equal to a total quantity of transmit ports (NG) in the first transmit port group;
when the quantity of first transmit port groups is equal to X, the quantity of first orthogonal code sequences is less than NG; and
when the quantity of first orthogonal code sequences is equal to NG, the quantity of first transmit port groups is less than X; and
receiving the reference signal based on the configuration information.

8. The method according to claim 7, wherein
the configuration information is carried in control signaling that comprises at least one of first sub-signaling or second sub-signaling;
the first sub-signaling indicates the configuration of the first transmit port group;
the second sub-signaling indicates the configuration of the first orthogonal code sequence;
a signaling size of the first sub-signaling is L1 and satisfies
$$L 1 = ⌊ {log}_{2}^{N / N G} ⌋ ;$$
a signaling size of the second sub-signaling is L2 and satisfies
$$L 2 = ⌊ {log}_{2}^{N G} ⌋ ;$$
and
N is a total quantity of transmit ports of the terminal device.

9. The method according to claim 8, wherein
X=N/NG; and
when NG is equal to N, and X is equal to 1, the control signaling comprises the second sub-signaling; or
when NG is equal to 1, and X is greater than 1 and equal to N, the control signaling comprises the first sub-signaling.

10. The method according to claim 7, further comprising:
restoring a first channel based on the reference signal.

11. The method according to claim 10, wherein restoring the first channel based on the reference signal comprises:
when the configuration information comprises the configuration of the first transmit port group and the configuration of the first orthogonal code sequence, obtaining a second channel based on the reference signal; or
when the configuration information comprises the configuration of the first orthogonal code sequence, and NG is equal to the total quantity N of transmit ports of the terminal device, obtaining a second channel based on the reference signal; or
when the configuration information comprises the configuration of the first transmit port group, obtaining a third channel based on the reference signal, and selecting a second channel from the third channel; or
when the configuration information comprises the configuration of the first orthogonal code sequence, and NG is less than the total quantity N of transmit ports of the terminal device, obtaining a fourth channel based on the reference signal, and selecting a second channel from the fourth channel; and
restoring the first channel based on the second channel.

12. The method according to claim 7, further comprising:
aggregating the X transmit port groups based on NG orthogonal code sequences to obtain a first vector, wherein a quantity of elements in the first vector is NMR1, M is a total quantity of receive ports of a network device, and R1 is a quantity of orthogonal frequency domain units;
concatenating, based on channel information of T time domain units, vectors that correspond to the first vector and that are in the T time domain units to obtain a first matrix, wherein a quantity of columns of the first matrix is NMR1, a quantity of rows of the first matrix is T, and T is greater than 1;
processing the first matrix to obtain a pattern of the reference signal; and
determining the configuration information based on the pattern of the reference signal.

13. The method according to claim 12, wherein processing the first matrix to obtain the pattern of the reference signal comprises:
decomposing the first matrix to obtain a second matrix, wherein a quantity of columns of the second matrix is NMR1, a quantity of rows of the second matrix is R2, and R2 is a quantity of orthogonal subsets in a set comprising the X transmit port groups and the NG orthogonal code sequences;
compressing the second matrix to obtain a third matrix and a fourth matrix, wherein a quantity of rows of the third matrix, a quantity of columns of the third matrix, a quantity of columns of the fourth matrix are R2, a quantity of rows of the fourth matrix is NMR1, and a location of a row in which an element whose value is 1 in the fourth matrix is located is used to determine a frequency domain position of the reference signal; and
determining the pattern of the reference signal based on the fourth matrix.

14. The method according to claim 12, further comprising:
processing a fifth matrix to obtain a sixth matrix, wherein the fifth matrix is a matrix comprising the N transmit ports, the M receive ports, and P frequency domain units, a quantity of rows of the sixth matrix is P, a quantity of columns of the sixth matrix is R1, a location of a row in which an element whose value is 1 in the sixth matrix is located is used to determine a frequency domain position of the reference signal, and P is a total quantity of frequency domain units;
constructing a second vector based on the N transmit ports, the M receive ports, and R1 frequency domain units that are selected by using the sixth matrix; and
splitting the N transmit ports based on the second vector to obtain the X transmit port groups.

15. A communication apparatus, comprising:
a memory comprising programming instructions; and
at least one processor configured to execute the programming instructions to enable the communication apparatus to:
receive configuration information, wherein
the configuration information indicates to send a reference signal through a first transmit port group using a first orthogonal code sequence;
the configuration information comprises at least one of a configuration of the first transmit port group or a configuration of the first orthogonal code sequence;
a quantity of first transmit port groups is less than or equal to a total quantity X of transmit port groups of the communication apparatus;
a quantity of first orthogonal code sequences is less than or equal to a total quantity of transmit ports (NG) in the first transmit port group;
when the quantity of first transmit port groups is equal to X, the quantity of first orthogonal code sequences is less than NG; and
when the quantity of first orthogonal code sequences is equal to NG, the quantity of first transmit port groups is less than X; and
send the reference signal based on the configuration information.

16. The communication apparatus according to claim 15, wherein
the configuration information is carried in control signaling that comprises at least one of first sub-signaling or second sub-signaling;
the first sub-signaling indicates the configuration of the first transmit port group;
the second sub-signaling indicates the configuration of the first orthogonal code sequence;
a signaling size of the first sub-signaling is L1 and satisfies
$$L 1 = ⌊ {log}_{2}^{N / N G} ⌋ ;$$
a signaling size of the second sub-signaling is L2 and satisfies
$$L 2 = ⌊ {log}_{2}^{N G} ⌋ ;$$
and
N is a total quantity of transmit ports of the communication apparatus.

17. The communication apparatus according to claim 16, wherein
X=N/NG; and
when NG is equal to N, and X is equal to 1, the control signaling comprises the second sub-signaling; or
when NG is equal to 1, and X is greater than 1 and equal to N, the control signaling comprises the first sub-signaling.

18. The communication apparatus according to claim 15, wherein
when the configuration information comprises the configuration of the first transmit port group and the configuration of the first orthogonal code sequence, the reference signal is sent through the first transmit port group using the first orthogonal code sequence; or
when the configuration information comprises the configuration of the first orthogonal code sequence, and NG is equal to the total quantity N of transmit ports of the communication apparatus, the reference signal is sent through the N transmit ports using the first orthogonal code sequence; or
when the configuration information comprises the configuration of the first transmit port group, the reference signal is sent through the first transmit port group using NG orthogonal code sequences; or
when the configuration information comprises the configuration of the first orthogonal code sequence, and NG is less than the total quantity N of transmit ports of the communication apparatus, the reference signal is sent through X transmit port groups using the first orthogonal code sequence.

19. The communication apparatus according to claim 15, wherein the communication apparatus is further to:
receive first indication information that indicates at least one of division of the transmit port groups or the orthogonal code sequence.

20. The communication apparatus according to claim 15, wherein the configuration information further comprises a configuration of a frequency domain position of the reference signal.
